(19) United States
(12) Patent Application Publication
(10) Pub. No.: US 2012/0156124 A1
(43) Pub. Date: Jun. 21, 2012

(54) Single Wall Carbon Nanotubes By Atmospheric Chemical Vapor Deposition

(75) Inventors: Amit Goyal, Harrison, NJ (US); Iqbal Zafar, Morristown, NJ (US)

(73) Assignee: NEW JERSEY INSTITUTE OF TECHNOLOGY, Newark, NJ (US)

(21) Appl. No.: 12/029,856

(22) Filed: Feb. 12, 2008

(51) Int. Cl. D01F 9/12; B82B 1/00; B82B 3/00

(52) U.S. Cl. 423/447.3; 977/843; 977/750

(57) ABSTRACT

The present disclosure provides for systems and methods for producing carbon nanotubes. More particularly, the present disclosure provides for improved systems and methods for producing single wall carbon nanotubes (SWNTs) by chemical vapor deposition (CVD) using a carbon source in the presence of a catalyst. In exemplary embodiments, the present disclosure provides for improved systems and methods for producing single wall carbon nanotubes (SWNTs) by chemical vapor deposition (CVD) using carbon monoxide (CO) disproportionation in the presence of a catalyst composition on a catalyst support material. In one embodiment, the present disclosure provides for systems and methods for producing single wall carbon nanotubes (SWNTs) by chemical vapor deposition (CVD) using carbon monoxide (CO) disproportionation with CO pressure from about 0.20 atm to about 1.0 atm in the presence of a cobalt/molybdenum catalyst composition on a magnesium oxide catalyst support.

### RELATED FEDERALLY SPONSORED RESEARCH

The work described in this patent disclosure was sponsored by the following Federal Agencies: U.S. Army ARDEC: DAAE30-03-D-1015 and DAAE30-02-C-1139.

### BACKGROUND

1. Technical Field

The present disclosure relates to systems and methods for producing carbon nanotubes, and, more particularly, to systems and methods for producing single wall carbon nanotubes (SWNTs) by chemical vapor deposition (CVD) using a carbon source in the presence of a catalyst.

2. Background Art

In general, there is a demand for carbon nanotubes in many industries. For example, carbon nanotubes typically possess properties (e.g., thermal, electrical and/or mechanical properties) that are useful in a myriad of different environments for commercial and industrial applications (e.g., electrical applications, semiconductor applications, mechanical applications, structural applications, health and medical applications, etc.). For example, multiwalled carbon nanotubes (MWNTs) and single wall carbon nanotubes (SWNTs) are used in structural applications or the like (e.g., high strength fibers and composites for large and small scale structural applications). However, one limiting factor for SWNTs is their comparatively higher cost than MWNTs.

In general, there are several methods for producing and/or synthesizing SWNTs. For example, SWNTs may be produced and/or synthesized by arc-discharge, laser ablation, plasma-enhanced chemical vapor deposition (PECVD) and thermal chemical vapor deposition (CVD). In general, carbon vapor generated from the carbon precursor diffuses into the catalytic metal particles, which typically leads to partial melting of the nanoparticles, and finally the precipitation of a graphitic filament or nanotube occurs at saturation.

In general, the arc-discharge and laser ablation methods are examples of techniques/methods sometimes used for the synthesis/production of SWNTs. For example, these methods evaporate carbon in arc-induced and laser-induced plasma, respectively, at temperatures typically in excess of 3000° C. for short reaction times generally of the order of a few micro- and milli seconds to a few minutes. Generally, because of the high growth temperature and the concomitant formation of a large fraction of disordered carbon, the scaled-up production costs by these methods are high.

In general, the CVD method is a moderate temperature (e.g., 700° to 1200° C.) technique involving relatively long reaction times, typically from minutes to hours. One CVD method for SWNT growth and/or production involves the disproportionation of carbon monoxide (CO) at high pressure and temperature, and this process is typically known as the HiPCO (high pressure CO) process. For example, using the HiPCO method, SWNT with a purity of about 75-80% have been achieved, but because of the high temperature and pressure used, and the need to remove relatively large amounts of catalyst, HiPCO nanotubes remain expensive.

Another method involves the disproportionation of CO under high pressures (but pressures that are typically lower than those utilized for the HiPCO process), over a catalyst on a support (e.g., over a bimetallic cobalt-molybdenum (Co—Mo) catalyst on a silica gel support). In general, this method is known as the CoMoCat method. SWNTs produced by the CoMoCat process generally use lower pressures than the HiPCO method, but typically the use of a silica support, which generally is difficult to dissolve, makes purification nearly as expensive as for the HiPCO method.

Thus, the production of SWNTs for bulk applications remains challenging and expensive due to various factors. For example, in regards to the HiPCO process, the high pressure processing is costly, and the removal of catalysts and amorphous carbon is expensive and inefficient. In addition, in regards to the CoMoCat process, for example, the removal of catalyst and support is expensive and inefficient.

Thus, despite efforts to date, a need remains for cost-effective, efficient systems and methods for producing SWNTs by chemical vapor deposition (CVD) using carbon monoxide (CO) disproportionation in the presence of a catalyst. These and other inefficiencies and opportunities for improvement are addressed and/or overcome by the systems and methods of the present disclosure.

### SUMMARY

The present disclosure provides for advantageous systems and methods for producing carbon nanotubes, and, more particularly, to systems and methods for producing single wall carbon nanotubes (SWNTs) by chemical vapor deposition (CVD) using a carbon source in the presence of a catalyst. In exemplary embodiments, the present disclosure provides for improved systems and methods for producing single wall carbon nanotubes (SWNTs) by chemical vapor deposition (CVD) using carbon monoxide (CO) disproportionation in the presence of a catalyst composition on a catalyst support material.

The present disclosure provides for a system/method for producing SWNTs including contacting a catalyst composition and a catalyst support material with at least one reducing gas in a reaction zone under reduction conditions; contacting the catalyst composition and the catalyst support material with a carbon feedstock in gaseous form at a pressure of from about 0.20 atm to about 1.0 atm and at a temperature of from about 600° C. to about 850° C. in the reaction zone under thermally-induced catalytic chemical vapor deposition conditions to produce single wall carbon nanotubes; wherein the particle size distribution of the catalyst composition and the catalyst support material is from about 2 μm to about 1000 μm. The present disclosure also provides for a system/method for producing SWNTs wherein the catalyst support material is magnesium oxide.

The present disclosure also provides for a system/method for producing SWNTs wherein the catalyst support material has an average particle size of about 44 μm. The present disclosure also provides for a system/method for producing SWNTs wherein the catalyst support material is magnesium oxide. The present disclosure also provides for a system/method for producing SWNTs wherein the catalyst support material is a −325 mesh powder. The present disclosure also provides for a system/method for producing SWNTs wherein the catalyst support material is magnesium oxide.

The present disclosure also provides for a system/method for producing SWNTs further including the step of sieving the catalyst support material and the catalyst composition prior to contacting the catalyst support material and the catalyst composition with the at least one reducing gas. The present disclosure also provides for a system/method for producing SWNTs wherein the particle size distribution has a highest volume fraction having particle sizes of from about 20 μm to about 300 μm. The present disclosure also provides for a system/method for producing SWNTs wherein the particle size distribution has a mean particle size of about 143 μm. The present disclosure also provides for a system/method for producing SWNTs wherein the catalyst support material and the catalyst composition are sieved using a 500 μm pore size or 35 mesh sieve.

The present disclosure also provides for a system/method for producing SWNTs wherein the catalyst composition and catalyst support material are contacted with the carbon feedstock at a temperature of about 700° C. The present disclosure also provides for a system/method for producing SWNTs wherein the carbon feedstock includes at least carbon monoxide as the carbon source. The present disclosure also provides for a system/method for producing SWNTs wherein the catalyst composition comprises an active catalyst precursor and a catalyst promoter precursor. The present disclosure also provides for a system/method for producing SWNTs wherein the active catalyst precursor is selected from the group consisting of cobalt, nickel, iron and combinations thereof. The present disclosure also provides for a system/method for producing SWNTs wherein the catalyst promoter precursor is molybdenum. The present disclosure also provides for a system/method for producing SWNTs wherein the active catalyst precursor is cobalt nitrate, the catalyst promoter precursor is ammonium heptamolybdate or molybdenum nitrate, and the catalyst support material is magnesium oxide.

The present disclosure also provides for a system/method for producing SWNTs wherein the single wall carbon nanotubes are produced at yields of about 10% by weight of initial catalyst composition and catalyst support material weight. The present disclosure also provides for a system/method for producing SWNTs wherein the carbon feedstock is contacted with the catalyst composition and the catalyst support material at carbon feedstock flow rates of from about 100 sccm to about 1000 sccm. The present disclosure also provides for a system/method for producing SWNTs wherein the carbon feedstock is contacted with the catalyst composition and the catalyst support material for a time period of from about 1 minute to about 30 minutes.

The present disclosure also provides for a system/method for producing SWNTs wherein the catalyst composition includes at least cobalt and the catalyst support material is magnesium oxide. The present disclosure also provides for a system/method for producing SWNTs wherein the catalyst composition includes at least molybdenum and the catalyst support material is magnesium oxide. The present disclosure also provides for a system/method for producing SWNTs wherein the catalyst composition includes at least cobalt and molybdenum, and the catalyst support material is magnesium oxide. The present disclosure also provides for a system/method for producing SWNTs wherein the catalyst composition includes at least cobalt and molybdenum, and wherein the cobalt to molybdenum ratio is about 1:4, and wherein the molybdenum is in excess of the cobalt to control the shape and size of the catalyst composition particles. The present disclosure also provides for a system/method for producing SWNTs wherein the catalyst support material is magnesium oxide and the carbon feedstock is carbon monoxide.

The present disclosure also provides for a system/method for producing SWNTs wherein the catalyst composition includes at least cobalt and molybdenum, and wherein the catalyst composition particles are spherical and monodisperse. The present disclosure also provides for a system/method for producing SWNTs wherein the catalyst composition particles are spherical and monodisperse. The present disclosure also provides for a system/method for producing SWNTs wherein the catalyst composition and catalyst support material are contacted with the carbon feedstock at a temperature of from about 650° C. to about 750° C. The present disclosure also provides for a system/method for producing SWNTs wherein the catalyst composition gradually expires independent of the pressure of the carbon feedstock. The present disclosure also provides for a system/method for producing SWNTs wherein the diameters of the single wall carbon nanotubes are controllable within a range.

The present disclosure also provides for a system/method for producing SWNTs including contacting a catalyst composition and a catalyst support material with at least one reducing gas in a reaction zone under reduction conditions; contacting the catalyst composition and the catalyst support material with a carbon feedstock in gaseous form at a pressure of from about 0.20 atm to about 1.0 atm and at a temperature of from about 600° C. to about 850° C. in the reaction zone under thermally-induced catalytic chemical vapor deposition conditions to produce single wall carbon nanotubes; contacting the single wall carbon nanotubes with acid to remove catalyst support material from the single wall carbon nanotubes to produce acid-purified single wall carbon nanotubes; partially oxidizing the acid-purified single wall carbon nanotubes with an oxidant under controlled humidity conditions at a temperature of from about 300° C. to about 450° C. to remove amorphous carbon from the single wall carbon nanotubes; wherein the particle size distribution of the catalyst composition and the catalyst support material is from about 2 μm to about 1000 μm. The present disclosure also provides for a system/method for producing SWNTs wherein the oxidant is water or water vapor. The present disclosure also provides for a system/method for producing SWNTs wherein the amount of carbon recovered after acid contact is about 10 weight percent of initial catalyst composition and catalyst support material weight.

Additional advantageous features, functions and applications of the disclosed systems and methods of the present disclosure will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 depicts Raman spectra using 632.8 nm laser excitation in the radial breathing mode region for nanotubes prepared using catalyst compositions: a) Mo only, b) Co only, c) Co:Mo 1:1, d) Co:Mo 1:2, e) Co:Mo 1:4, and f) Co:Mo 5:1;

FIG. 2 depicts Raman spectra using 632.8 nm laser excitation in the disorder and tangential mode region for catalyst compositions: a) Mo only, b) Co only, c) Co:Mo 1:1, d) Co:Mo 1:2, e) Co:Mo 1:4, f) Co:Mo 5:1;

FIG. 3 depicts SEM images for as-prepared SWNT samples prepared over different catalysts are shown: FIG. 3a: Mo only, FIG. 3b: Co only, FIG. 3c: Co:Mo 1:1, FIG. 3d: Co:Mo 1:2, FIG. 3e: Co:Mo 1:4, and FIG. 3f: Co:Mo 5:1;

FIG. 4 depicts the ratio of disorder (D) to tangential mode (G⁺) Raman line intensities for SWNTs synthesized versus catalyst compositions used;

FIG. 5 depicts Binary phase diagrams: a) C—Co [Source: Ishida, 1991], and b) Co—Mo [Source: Brewer, 1980];

FIG. 6 depicts SEM image and EDX elemental analysis for the Co:Mo 1:4 catalyst;

FIG. 7 depicts exit CO₂ gas concentration at different SWNT deposition temperatures;

FIG. 8 depicts Raman spectra with 632.8 nm excitation for SWNTs prepared using Co:Mo 1:4 catalyst at: a) 650° C., b) 700° C., and c) 750° C.;

FIG. 9 depicts SEM images of as-prepared SWNTs at different temperatures: a) 650° C., b) 675° C., c) 700° C., d) 700° C., e) 725° C., and f) 750° C.;

FIG. 10 depicts Raman spectra obtained with 632.8 nm laser excitation of as-prepared SWNTs using different flow rates;

FIG. 11 depicts exit CO₂ gas concentration data at different flow rates;

FIG. 12 depicts Raman spectra using 632.8 nm excitation at different initial partial pressures of carbon monoxide: a) 0.2 atm, b) 0.4 atm, c) 0.6 atm, d) 0.8 atm, and e) 1 atm;

FIG. 13 depicts EDX maps showing distribution of cobalt catalyst (green dots) and carbon (red dots) at different inlet pressures of carbon monoxide used;

FIG. 14 depicts XRD diffractograms: on top as prepared SWNTs with catalyst and support, bottom depicts purified samples with 4-6M HCl;

FIG. 15 depicts TEM images of SWNTs: a) as-prepared with catalyst and support, b) after HCl acid purification, and c) after partial oxidation;

FIG. 16 depicts TEM image for a bundle of SWNT synthesized using the HiPCO method;

FIG. 17 depicts a comparison of TEM images and Raman data for purified CO-CVD, CoMoCat [Source: Kitiyanan, 2002], and HiPCO [from Carbon Nanotechnologies Inc.] processes;

FIG. 18 depicts a schematic showing the sequence of steps in reaction-limited catalytic deposition of SWNTs;

FIG. 19 depicts a plot of carbon deposited (C_{c}) vs. time (t);

FIG. 20 depicts determination of K_{reaction} by plotting the carbon deposited (C_{c}) vs (P_{CO}²/(P_{COinitial}−P_{CO})×t;

FIG. 21 depicts an exemplary particle size distribution of Co:Mo/MgO catalyst/support in a ratio of 1:4 Co:Mo/MgO;

FIG. 22 depicts a plot of pressure drop versus nitrogen flow;

FIG. 23 depicts an exemplary experimental setup for scaled-up SWNT synthesis: a) photograph of the fluidized CVD setup used in this work. Note color of the catalyst/support bed which is white, and b) schematic for growth of SWNTs using fluidized bed CVD;

FIG. 24 depicts exemplary photographs of fluidized bed during a run; a) before flow of gases bed height is 10.5 cm; and b) after gas flow bed height is 13.5 cm. Note darkening of catalyst/support bed due to carbon deposition;

FIG. 25 depicts SEM images of SWNTs from fluidized CVD run: a) as prepared SWNTs, b) Acid purified SWNTs; and

FIG. 26 depicts Raman spectrum obtained with 632.8 nm laser excitation for purified SWNTs synthesized using a fluidized bed reactor.

### DETAILED DESCRIPTION

The present disclosure provides for systems and methods for producing carbon nanotubes. More particularly, the present disclosure provides for improved systems and methods for producing single wall carbon nanotubes (SWNTs) by chemical vapor deposition (CVD) using a carbon feedstock in the presence of a catalyst on a catalyst support material. In exemplary embodiments, the present disclosure provides for improved systems and methods for producing SWNTs by CVD using carbon monoxide (CO) disproportionation in the presence of a catalyst. In one embodiment, the present disclosure provides for systems and methods for producing SWNTs by CVD using carbon monoxide (CO) disproportionation in the presence of a cobalt/molybdenum catalyst composition on a magnesium oxide catalyst support.

In exemplary embodiments, the present disclosure provides for systems and methods for producing SWNTs by contacting a catalyst composition and a catalyst support material with at least one reducing gas in a reaction zone under reduction conditions, contacting the catalyst composition and the catalyst support material with a carbon feedstock in gaseous form at a pressure of from about 0.20 atm to about 1.0 atm and at a temperature of from about 600° C. to about 850° C. in the reaction zone under thermally-induced catalytic chemical vapor deposition conditions to produce single wall carbon nanotubes, contacting the single wall carbon nanotubes with acid to remove catalyst support material from the single wall carbon nanotubes to produce acid-purified single wall carbon nanotubes, partially oxidizing the acid-purified single wall carbon nanotubes with an oxidant under controlled humidity conditions at a temperature of from about 300° C. to about 450° C. to remove amorphous carbon from the single wall carbon nanotubes, and wherein the particle size distribution of the catalyst composition and the catalyst support material is from about 2 μm to about 1000 μm.

The present disclosure also provides for systems and methods for producing SWNTs, wherein the catalyst composition comprises an active catalyst precursor and a catalyst promoter precursor. The present disclosure also provides for systems and methods for producing SWNTs, wherein the active catalyst precursor is selected from the group consisting of cobalt, nickel, iron and combinations thereof. The present disclosure also provides for systems and methods for producing SWNTs, wherein the catalyst promoter precursor is molybdenum. The present disclosure also provides for systems and methods for producing SWNTs, wherein the active catalyst precursor is cobalt nitrate, the catalyst promoter precursor is ammonium heptamolybdate or molybdenum nitrate, and the catalyst support material is magnesium oxide. The present disclosure also provides for systems and methods for producing SWNTs, wherein the single wall carbon nanotubes are produced at yields of about 10% by weight of initial catalyst composition and catalyst support material weight.

The present disclosure also provides for systems and methods for producing SWNTs, wherein the carbon feedstock is contacted with the catalyst composition and the catalyst support material for a time period of from about 1 minute to about 30 minutes. The present disclosure also provides for systems and methods for producing SWNTs, wherein the catalyst composition includes at least cobalt and molybdenum, and wherein the cobalt to molybdenum ratio is about 1:4, and wherein the molybdenum is in excess of the cobalt to control the shape and size of the catalyst composition particles. The present disclosure also provides for systems and methods for producing SWNTs, wherein the catalyst composition particles are spherical and monodisperse.

The present disclosure also provides for systems and methods for producing SWNTs, wherein the amount of carbon recovered after acid contact is about 10 weight percent of initial catalyst composition and catalyst support material weight. The present disclosure also provides for systems and methods for producing SWNTs, wherein the catalyst composition gradually expires independent of the pressure of the carbon feedstock.

Current practice provides that some CVD methods for SWNT growth and/or production involving the disproportionation of carbon monoxide (CO) at high pressure and temperature (e.g., the HiPCO method) are expensive and inefficient, due in part, for example, to the costly high pressure processing, and the expensive and inefficient removal of catalysts and amorphous carbon associated with these methods. Current practice also provides that other CVD methods for SWNT growth and/or production involving the disproportionation of carbon monoxide (CO) under pressures typically lower than those utilized for the HiPCO process, over a catalyst on a support (e.g., the CoMoCat method) are expensive and inefficient, due in part, for example, to the costly and inefficient removal of catalyst and support.

In general, the present disclosure provides for improved and cost effective systems and methods for producing single wall carbon nanotubes (SWNTs) by chemical vapor deposition (CVD) using carbon monoxide (CO) disproportionation in the presence of a catalyst. In exemplary embodiments, the present disclosure provides for improved systems and methods for producing SWNTs by atmospheric or near atmospheric CVD using CO disproportionation in the presence of a catalyst supported on a support, thereby providing a significant manufacturing and commercial advantage as a result. In one embodiment, the present disclosure provides for improved and cost effective systems and methods for producing SWNTs by atmospheric or near atmospheric CVD using CO disproportionation in the presence of a bimetallic Co,Mo catalyst composition supported on a MgO catalyst support. In an exemplary embodiment, the present disclosure also provides for a purification step, wherein the catalyst support material (e.g., MgO) is readily and/or rapidly removed in the purification step by dilute acid treatment (e.g., dilute hydrochloric acid treatment), thereby providing a significant manufacturing and commercial advantage as a result.

In general, the present disclosure provides for improved and cost effective systems and methods for producing SWNTs at yields of about 10% by weight. In exemplary embodiments, the present disclosure provides for systems and methods for SWNT production at yields of about 10% by weight, by controlling catalyst shape, which is determined by, inter alia, the bimetallic concentration ratios and CO partial pressure and flow rates. In one embodiment, the present disclosure provides for systems and methods for the production of high quality SWNTs by post-synthesis acid purification to remove the catalyst support material (e.g., MgO) and/or catalyst composition, and low temperature oxidation or partial oxidation with an oxidant (e.g., water or water vapor) under controlled humidity conditions (e.g., in humid nitrogen at a temperature of from about 300° C. to about 450° C.) to remove amorphous carbon on the nanotube sidewalls or the like. In an exemplary embodiment, the post-synthesis acid purification step is carried out rapidly with dilute acids (e.g., dilute hydrochloric acid treatment) to remove catalyst support material (e.g., MgO) and/or catalyst composition (e.g., Co, Mo catalyst composition).

In exemplary embodiments, the present disclosure provides for carbon monoxide (CO) chemical vapor deposition (CO-CVD) system and methods for production and/or synthesis of single wall carbon nanotubes (SWNTs). The present disclosure will be further described with respect to the following examples; however, the scope of the disclosure is not limited thereby. Unless otherwise indicated all parts and percentages are by weight. The following examples illustrate the process of the disclosure using carbon monoxide (CO) chemical vapor deposition (CO-CVD) system and methods for production and/or synthesis of single wall carbon nanotubes (SWNTs) as illustrated in the examples.

### Example 1

SWNTs were synthesized in powder form using carbon monoxide (CO) as the carbon source and magnesium oxide (MgO) as the catalyst support material. A detailed parametric study of the various factors influencing the growth of the SWNTs was performed. More particularly, the effects of catalyst type, bimetallic catalyst composition, growth temperature, and flow rate and partial pressure of the carbon source, were investigated. In general, the SWNT growth process consisted of three stages, namely: catalyst/support preparation, catalyst/support calcination and reduction, and finally, SWNT growth followed by purification.

### Catalyst Preparation:

Sample catalysts/supports were prepared by a wet mixing and combustion synthesis method. Magnesium nitrate hexahydrate [Mg(NO₃).6H₂O], cobalt nitrate hexahydrate [Co(NO₃).6H₂O], ammonium heptamolybdate [(NH₄)6Mo₇O₂₄.4H₂O] and citric acid (all from Sigma Aldrich) were mixed with enough distilled water to form a clear solution. Part of the solution was poured into quartz or ceramic boats and fired for 5-10 minutes at a temperature of 550-560° C. in a pre-heated furnace resulting in a fine creamy powder which was ground further using a mortar and pestle. Catalyst/support oxides in different atomic ratios MgO_{(1-x-y)}COₓMo_{y} were obtained. In an alternative approach to obtain larger quantities of catalyst for fluidization experiments, another protocol for making the catalyst/support combinations was used. An aqueous solution of Co:Mo catalyst precursors in a 1:4 ratio was mixed with magnesium oxide (MgO) (Sigma Aldrich) powder having an average particle size of 44 μm and citric acid, followed by calcination at a temperature of about 550° C. in large ceramic trays. The powder was then sieved using a 500 μm mesh and further annealed to remove moisture since water can generally act as a weak oxidant to remove SWNTs during the growth process.

### Calcination and Reduction:

The calcination and reduction of the catalyst/support was performed using a microprocessor controlled three-zone (Applied Tests Systems Inc.), horizontal tube furnace. Desired amounts of catalyst/support precursors were placed in quartz boats and covered with Toray® carbon paper. The catalyst was calcined by heating to about 500° C. for a period of 30 min. under ambient pressure. In general, this step converted the nitrate and molybdate salts into their respective oxides. The setup was pumped (GE, ¾ HP) to 10⁻² torr before the reduction step and backfilled with hydrogen (Spectra Gases Inc, research grade) to atmospheric pressure. The temperature was maintained at about 500° C. for a period of 35 min. and a flow rate of 100 sccm (standard cubic centimeters per minute). For the fluidized bed experiments less than 5% H₂ mixed with nitrogen (N₂) (e.g., Matheson, ultra high purity) was used for safety reasons as the reduction gas since, in general, hydrogen is known to form a combustible mixture with air in the 4% to 74% range with an auto-ignition temperature of 571° C.

### Nanotube Growth:

After pumping out the hydrogen in the last stage, the temperature was raised to 600-850° C. and the system was backfilled with flowing CO (Matheson, 99.9% research grade) at atmospheric pressure and flow rates between 100-1000 sccm. The growth conditions were maintained for a period of 1-30 min. The system was then filled with flowing argon (Matheson, research grade) and allowed to cool after each run to room temperature. For the scaled-up fluidized bed experiment, CO was diluted with nitrogen.

### Purification:

As-prepared samples were treated with 4-6 M HCl (Sigma Aldrich, 36% by vol.) and mixed well using a magnetic stirrer for 45 min. to 1 hour in order to remove the MgO support and catalytic metals. The solution was then vacuum-filtered and the solids deposited on the filter paper (Millipore, PTFE 47 mm dia, 0.1 μm pore size) were allowed to dry for further analysis and/or characterization. In addition, the nanotubes obtained from the filter paper were suspended in water using a non-ionic surfactant, Triton-X100 (Supelco) and again vacuum-filtered. After drying in ambient conditions, a free standing nanotube sheet, paper or the like was obtained. In order to remove the amorphous carbon remaining after the acid treatment a limited or partial oxidation step was carried out using water vapor as oxidant, for example. A small amount of water was placed in the first zone of the furnace and argon was used as the carrier gas. The nanotube paper or powder sample was placed in third zone and oxidation was performed at 450° C. Thermogravimetric (e.g., Hata, 2004) data have shown that the oxidation temperature of SWNTs takes place above 450° C., while amorphous carbon is typically removed in the 300-450° C. temperature range.

### Effect of Catalyst Composition:

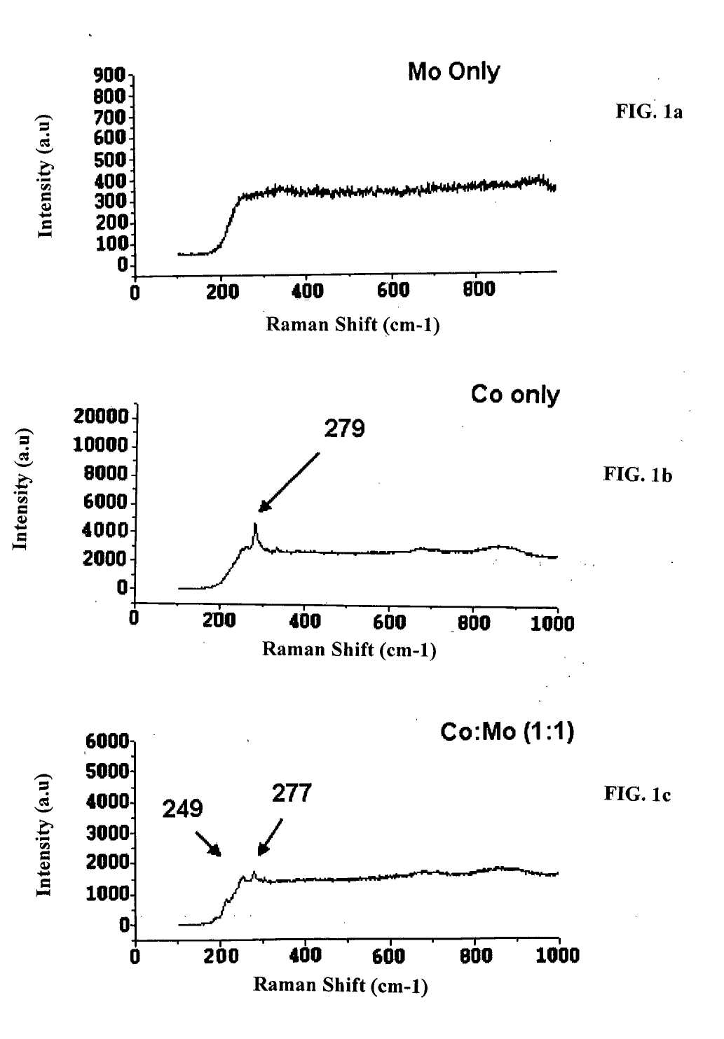

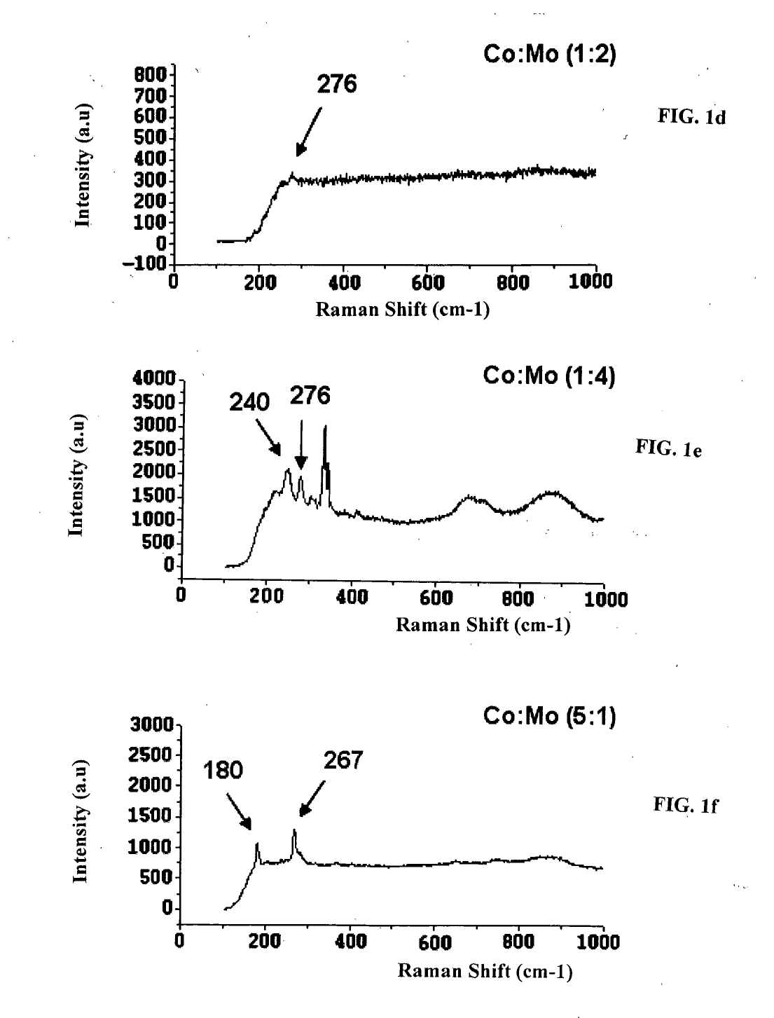

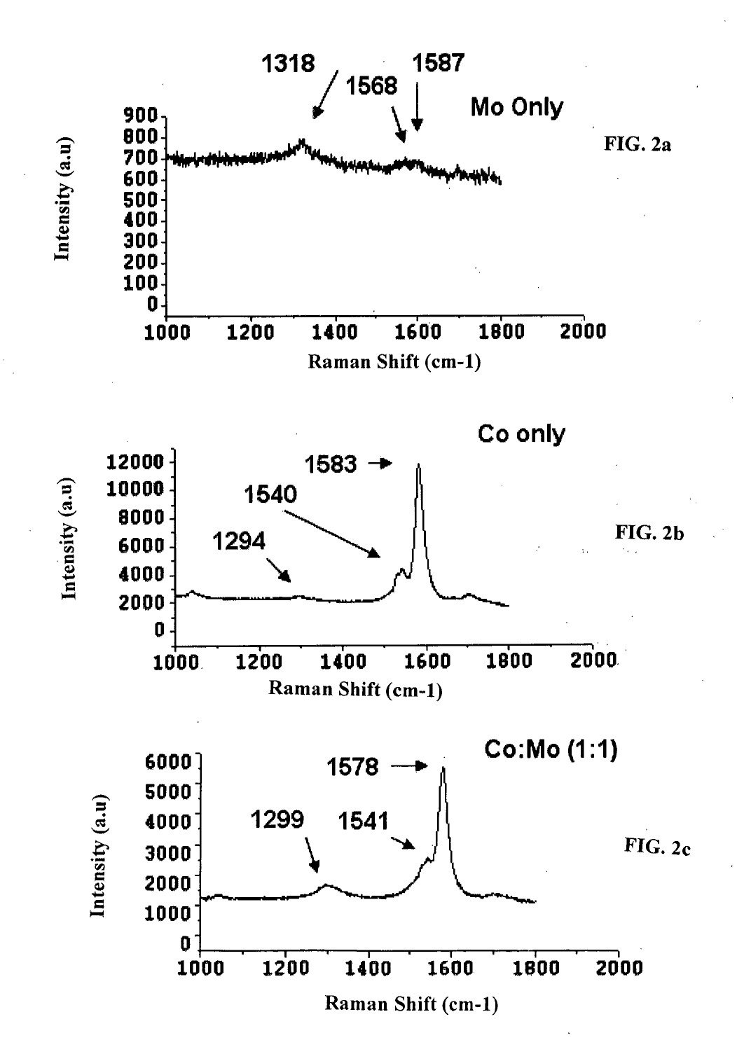

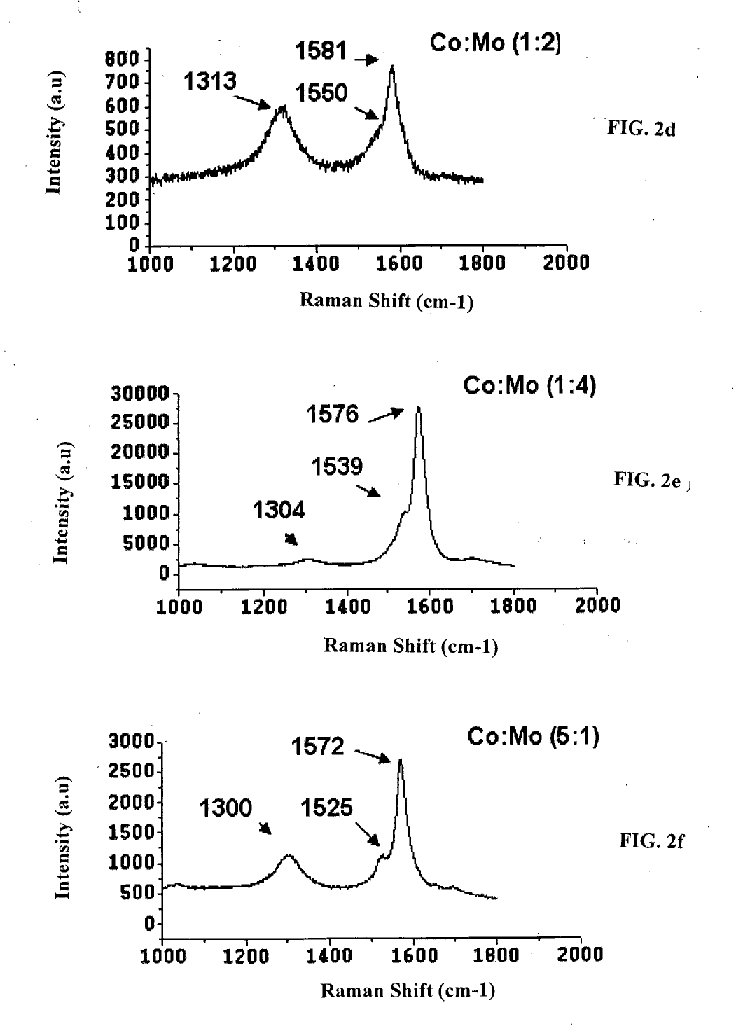

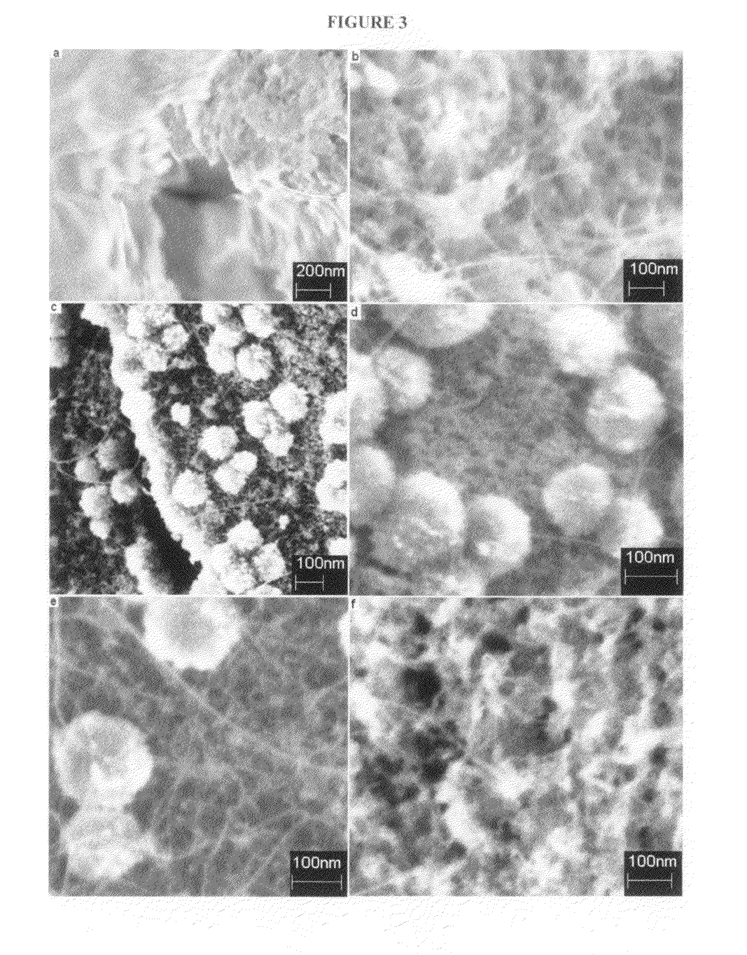

A total of six different catalyst/support compositions were used to grow SWNTs while keeping all other variables, such as, for example, synthesis temperature (700° C.), flow rates (500 sccm), carbon source (100% CO) and growth time (30 min.), constant. As described above, the catalyst composition was prepared in various atomic percent combinations with MgO as the common support material. All of the calculations were performed based on a starting material comprised of 3 gms of MgNO₃. Six combinations were used: 1) Mo_{0.05}MgO_{0.95}, 2) CO_{0.05}MgO_{0.95}, 3) CO_{0.01}Mo_{0.01}MgO_{0.98}, 4) Co_{0.01}Mo_{0.02}MgO_{0.97}, 5) Co_{0.01}Mo_{0.04}MgO_{0.95}, and 6) Co_{0.05}Mo_{0.01}MgO_{0.94}. The Raman spectra displayed here are divided into the radial breathing mode (RBM) region below 1000 cm⁻¹ and the tangential mode (TM) region around 1600 cm⁻¹ for the above-mentioned catalysts and are shown in FIGS. 1a-1f and 2a-2f, respectively. The SEM images of the samples prepared using the above-mentioned catalyst combinations are shown in FIG. 3. As depicted in FIG. 3, the SEM images for as-prepared SWNT samples prepared over different catalysts are shown: FIG. 3a: Mo only, FIG. 3b: Co only, FIG. 3c: Co:Mo 1:1, FIG. 3d: Co:Mo 1:2, FIG. 3e: Co:Mo 1:4, and FIG. 3f: Co:Mo 5:1. From the Raman spectra in FIGS. 1a and 2a for samples prepared using just Mo as catalyst, no RBM and TM features are observed indicating that SWNTs are not formed. The Raman spectra in FIGS. 1b and 2b for samples prepared using Co alone as catalyst indicate significant growth of SWNTs.

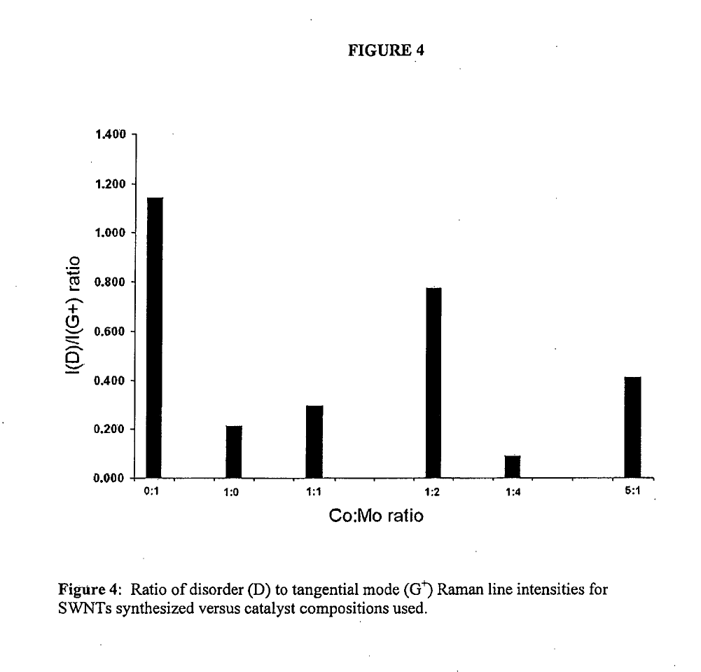

The observed RBM line at 279 cm⁻¹ corresponds to the presence of SWNTs with an average individual tube diameter of 0.84 nm (calculated using the equation: dₜ=(238/ω_{RBM})^{1.075})). SWNT-specific splitting of the tangential mode into two primary components at 1545 cm⁻¹ (G⁻ peak) and 1581 cm⁻¹ (G⁺ peak) were also observed. The presence of few RBM lines indicated a narrow diameter distribution of the SWNTs formed using Co alone as catalyst. However, the monometallic cobalt catalyst particles have no regular shape and a random size distribution, as shown from the SEM image in FIG. 3b, where a random distribution with irregular shape and size of the metal particles can be observed. As molybdenum was mixed with cobalt to form bimetallic catalysts, the Raman spectra shown in FIGS. 1c-1f and FIGS. 2c-2f for ratios 1:1, 1:2, 1:4, 5:1 show clear features of SWNTs in both the RBM and TM frequency regions, respectively. The peak positions for each catalyst combination, calculated diameters from the RBM peaks and the ratio of intensity (I) of the disorder mode D line to that of the primary tangential mode G⁺ line are listed in Table 1. The SEM images in FIGS. 3c-3e show essentially monodispersed catalyst particles when molybdenum is equal to or in excess of cobalt metal, for example, in the 1:1, 1:2, 1:4 Co:Mo ratios, respectively. However, when cobalt metal is in excess as in case of 5:1 Co:Mo ratio, the catalyst shape becomes irregular and the size distribution size becomes random. In addition, from FIG. 4, a plot of the ratio of the intensities of the disorder line (D) and tangential mode (G⁺) line [I(D)/I(G⁺)] gives an indication of the purity (and hence the quality) of the SWNTs prepared. In general, the lower the value of this ratio, the average quality of the nanotubes synthesized is improved. The lowest value of I(D)/I(G⁺)=0.090 is observed in case of samples prepared using a Co:Mo ratio of 1:4 indicating that this catalyst combination has the highest selectivity towards SWNT growth. Based on the Raman data, the molybdenum acts as a promoter and/or catalyst promoter precursor and cobalt acts as the active catalyst and/or active catalyst precursor for SWNT growth. In addition, introduction of molybdenum typically makes the bimetallic catalyst particles spherical and monodisperse, and thus better suited for the efficient growth of SWNTs.

TABLE 1
Raman Peak Positions, Calculated SWNT Diameters and Ratio of D/G+ Line Intensities

| | RBM | SWNT | | TM peaks | | D peak | G⁺ peak | | |
|---|---|---|---|---|---|---|---|---|---|
| | Peaks | Diameter | D peak | (cm⁻¹) | | intensity | intensity | | |
| Co:Mo | cm⁻¹ | (nm) | (cm⁻¹) | G⁻ | G⁺ | (a.u) | (a.u) | I(D)/I(G⁺) | Yield |
| 0:1 | No | N/A | 1318 | 1568 | 1587 | 790 | 691 | 1.143 | 0 |
| | peak | | | | | | | | |
| 1:0 | 279 | 0.84 | 1294 | 1540 | 1583 | 2497 | 11712 | 0.213 | 11 |
| 1:1 | 249 | 0.95 | 1299 | 1541 | 1578 | 1653 | 5573 | 0.297 | 6.3 |
| | 277 | 0.85 | | | | | | | |
| 1:2 | 276 | 0.85 | 1313 | 1550 | 1581 | 594 | 768 | 0.773 | 7.5 |
| 1:4 | 240 | 0.99 | 1304 | 1539 | 1576 | 2497 | 27775 | 0.090 | 10 |
| | 276 | 0.85 | | | | | | | |
| 5:1 | 180 | 1.35 | 1300 | 1525 | 1572 | 1110 | 2691 | 0.412 | 12 to 18 |
| | 267 | 0.88 | | | | | | | |

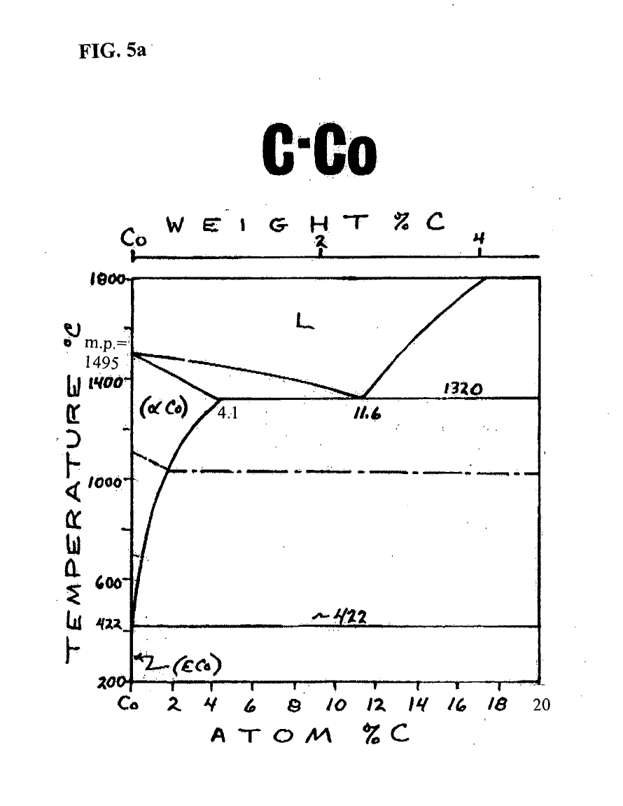

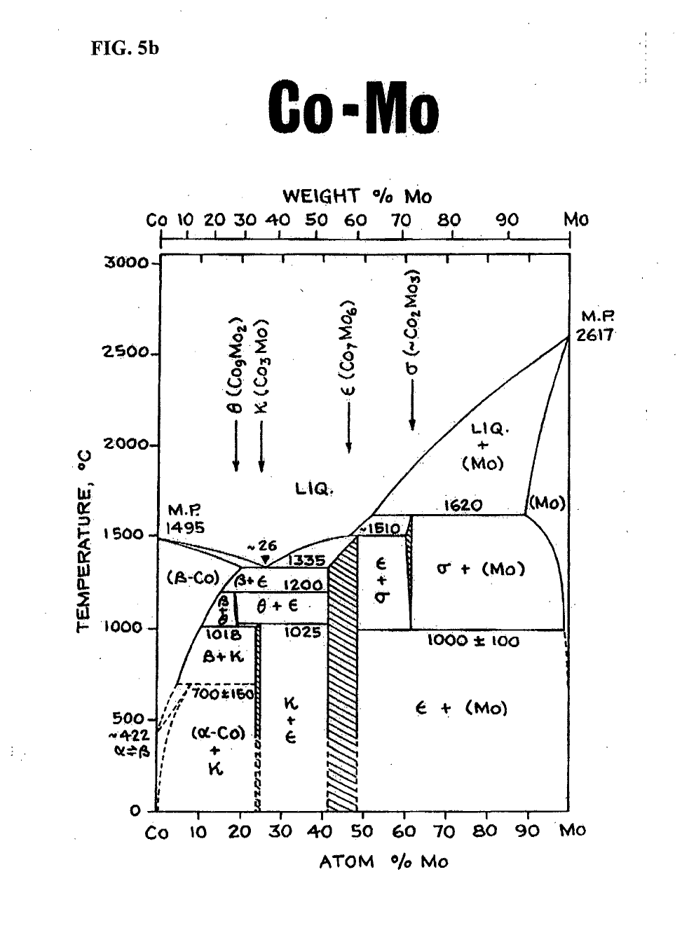

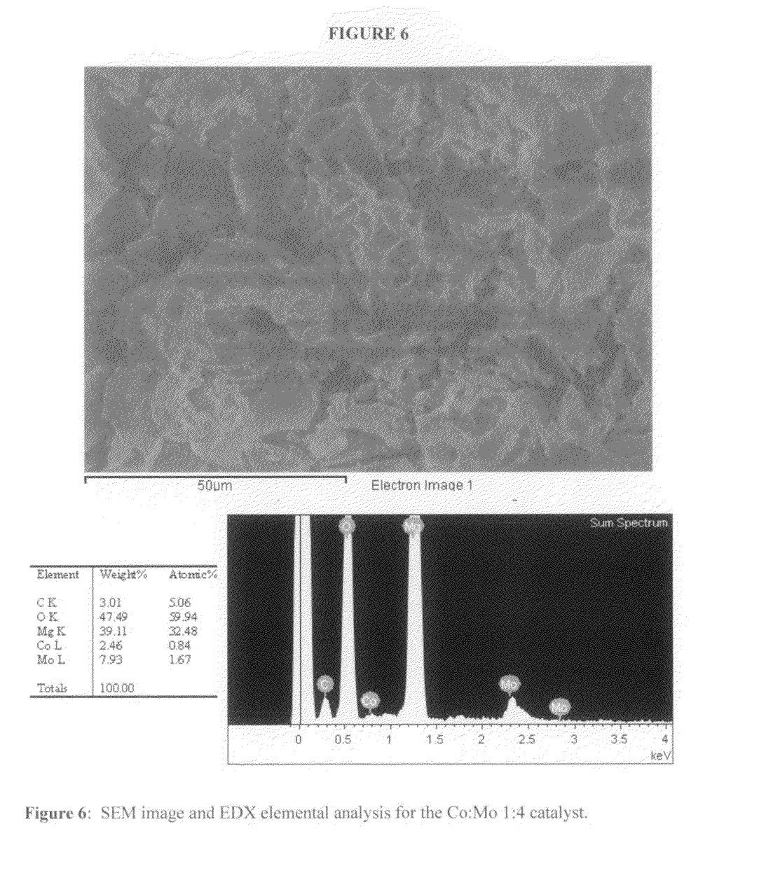

Table 1 lists the yields defined in terms of the weight of carbon deposited (after purification) to the total weight of starting catalyst for the various combination ratios. However, one must note that this yield corresponds to the total carbon deposited and not only to just SWNTs. Later it is shown that by using a simple EDX image analysis how different forms of carbon segregate. In addition, from the binary phase diagrams shown in FIG. 5 for C—Co and Co—Mo, the catalyst phase favorable for SWNT growth and the carbon adsorbed by the active cobalt catalyst may be determined. From FIG. 5a it may be seen that carbon dissolves in the a-phase of Co metal in the 700°-1000° C. temperature range. FIG. 5b also shows that the Co present in the catalyst composition at a temperature of 550-560° C. is in the β-phase. However, at the nanotube growth temperature of around 700° C., β-Co converts to α-Co in the presence of Mo. Under these conditions around 10% (atomic) (˜10% (by weight)) Mo is dissolved in cobalt whereas, around 1% (atomic) (˜0.17% (weight)) of carbon can dissolve in cobalt under the same conditions. This concentration of carbon in cobalt may be considered to be supersaturated, as it represents the concentration at which carbon begins to precipitate out in the form of SWNTs. Elemental analyses by EDX was performed in order to confirm the distribution of catalyst over the support. As depicted in FIG. 6, the ratio of Co:Mo agrees well with the composition desired over the entire surface scanned. The table at the bottom left of FIG. 6 lists the elemental weight and atomic percentages.

### Effect of Growth Temperature:

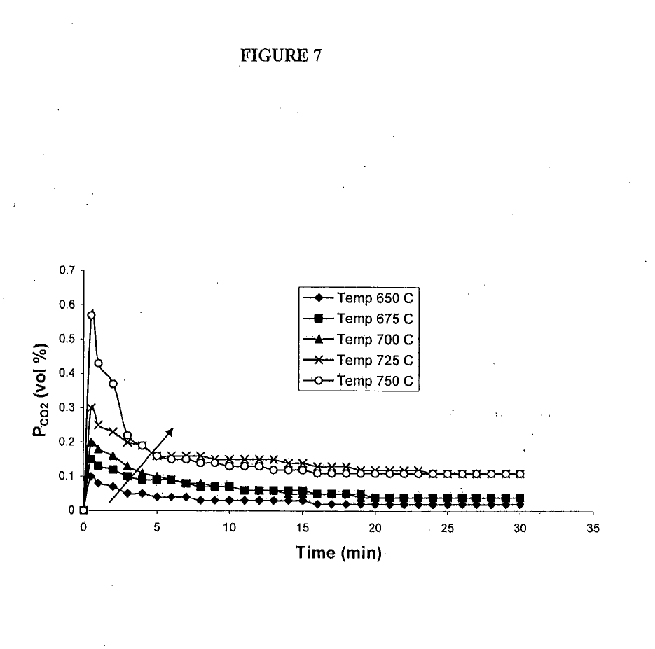

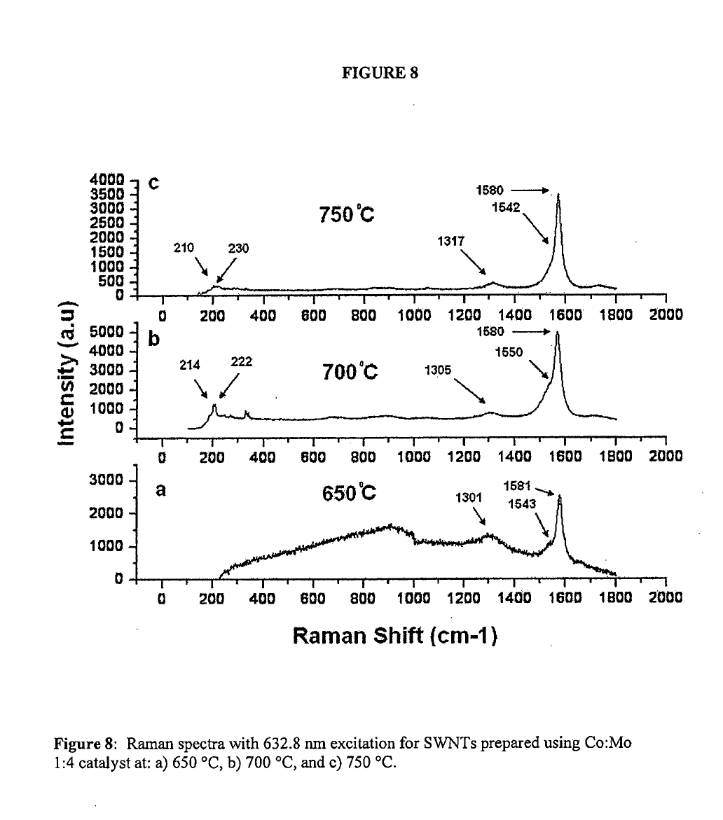

SWNTs were grown at five different temperatures ranging from about 625° C. to about 750° C. while keeping all other variables such as, for example, catalyst composition (Co:Mo=1:4), carbon source (100% CO), CO flow rate (500 sccm), and growth time (30 min.), constant. The Co:Mo catalyst in ratio of 1:4 shown in FIG. 6 was used to study the effect of temperature. Specific experimental conditions listed below were maintained at constant values in order to avoid deviation from experiment to experiment. Constant total flow rate of reactant gases was maintained at about 500 sccm. Constant amount of about 0.03 gm of catalyst was used in every run. Catalyst used throughout the studies was prepared in a single large batch (for example, a master batch of 3-5 gms of Co:Mo 1:4 catalyst was prepared for the studies reported here). The optimum flow rate required for the CO₂ sensor (Rosemount Analytical model 880A) is 500 sccm (controlled using a CO mass flow meter: Sierra Instruments range 0-2 L/min) as described in the manufacturer's manual. 0.030 gm of catalyst was found to grow enough nanotubes for Raman, SEM and TEM analyses. For XRD measurements single nanotube synthesis experiments were conducted to obtain the 500 mg of nanotubes needed. The CO₂ sensor, which was equipped with a 2-point calibration system, was calibrated with CO₂ gas diluted with argon. FIG. 7 shows the exit concentration of CO₂ at different deposition temperatures collected over 30 minutes. It can be observed that as the deposition temperature is increased the CO₂ formation increases and consequently the formation of carbon deposited also increases following the Boudouard reaction [2CO (g) [symbol] C (s)+CO₂ (g)]. The Raman spectra shown in FIG. 8 for samples prepared at 650, 700 and 750° C. shows that one effective temperature for nanotube formation is about 700° C. Nanotube growth may begin at about 650° C. since very weak Raman scattering can be observed with no distinct peaks in RBM mode region. However, as the temperature is raised to 700° C., RBM lines with peaks at 214 and 222 cm⁻¹ corresponding to 1.12 and 1.08 nm diameter SWNTs can be observed.

As the temperature is raised further to 750° C., the RBM line intensities decrease but it is not clear whether a majority of the tubes formed are single- or multi-walled. Another possibility is that at higher growth temperatures the smaller diameter SWNTs are destroyed, and the RBM lines of the larger diameter nanotubes remaining lie at frequencies below the approximately 150 cm⁻¹ lower limit of the Raman system used in this study. At lower temperatures the Raman line near 1300 cm⁻¹ associated with disordered carbon is more intense due to the formation of amorphous carbon and/or defects on the nanotube sidewalls. With increasing growth temperature the intensity of the 1300 cm⁻¹ line decreases due to the greater crystallinity of the nanotube sidewalls.

The I(D)/I(G⁺) ratio values for samples prepared at 650, 700 and 750° C. are 0.539, 0.160, 0.129, respectively. The carbon yield calculated on a weight basis as defined earlier matches well with the exit gas concentration measurements. A representative calculation for 700° C. is shown in Table 3. Cumulative amounts of carbon deposited (Cc) in moles at the end of 30 minutes is 0.00026775 mol, which is equivalent to 0.00321 gms of carbon deposited with 10.7% of starting catalyst/support material (0.030 gm). The amount of carbon recovered after acid purification is about 0.0030 gm, which is 10% of the starting catalyst/support material (shown in Table 2 for 700° C., where the balance used could measure the weight only to 3 decimal places).

TABLE 2
Raman Peak Positions, Calculated SWNT Diameters and Ratio
of D/G⁺ Intensities at Different Growth Temperatures

| | RBM | SWNT | | TM peaks | | D peak | G⁺ peak | | |
|---|---|---|---|---|---|---|---|---|---|
| Temp | Peaks | Diameter | D peak | (cm⁻¹) | | intensity | intensity | | |
| (° C.) | cm⁻¹ | (nm) | (cm⁻¹) | G⁻ | G⁺ | (a.u) | (a.u) | I(D)/I(G⁺) | Yield |
| 650 | No peak | N/A | 1301 | 1543 | 1581 | 1373 | 2547 | 0.539 | 6 |
| 700 | 214 | 1.12 | 1305 | 1550 | 1580 | 805 | 5019 | 0.160 | 10 |
| | 222 | 1.08 | | | | | | | |
| 750 | 210 | 1.14 | 1317 | 1542 | 1580 | 451 | 3504 | 0.129 | 13.33 |
| | 230 | 1.04 | | | | | | | |

TABLE 3
Estimates of Carbon Deposition using CO₂ Exit Gas Concentrations at 700° C.

| Time | Conc. Vol | PCO₂ | PCO | | | Cc | Cc |
|---|---|---|---|---|---|---|---|
| (min) | % CO₂ | (atm) | (atm) | X | X*vol % CO₂ | (mol/time) | (mol) |
| 0 | 0 | 0 | 1 | | 0 | 0 | 0 |
| 0.5 | 0.2 | 0.00998 | 0.99002 | 499.0020 | 0.998003992 | 4.45537E−05 | 2.22769E−05 |
| 1 | 0.18 | 0.008984 | 0.991016 | 499.1016 | 0.898382911 | 4.01064E−05 | 4.01064E−05 |
| 2 | 0.16 | 0.007987 | 0.992013 | 499.2013 | 0.798722045 | 3.56572E−05 | 7.13145E−05 |
| 3 | 0.13 | 0.006492 | 0.993508 | 499.3508 | 0.649156097 | 2.89802E−05 | 8.69405E−05 |
| 4 | 0.11 | 0.005494 | 0.994506 | 499.4506 | 0.549395665 | 2.45266E−05 | 9.81064E−05 |
| 5 | 0.1 | 0.004995 | 0.995005 | 499.5005 | 0.499500500 | 2.22991E−05 | 1.11496E−04 |
| 6 | 0.09 | 0.004496 | 0.995504 | 499.5504 | 0.449595364 | 2.00712E−05 | 1.20427E−04 |
| 7 | 0.08 | 0.003997 | 0.996003 | 499.6003 | 0.399680256 | 1.78429E−05 | 1.24900E−04 |
| 8 | 0.08 | 0.003997 | 0.996003 | 499.6003 | 0.399680256 | 1.78429E−05 | 1.42743E−04 |
| 9 | 0.07 | 0.003498 | 0.996502 | 499.6502 | 0.349755171 | 1.56141E−05 | 1.40527E−04 |
| 10 | 0.07 | 0.003498 | 0.996502 | 499.6502 | 0.349755171 | 1.56141E−05 | 1.56141E−04 |
| 11 | 0.06 | 0.002998 | 0.997002 | 499.7002 | 0.299820108 | 1.33848E−05 | 1.47233E−04 |
| 12 | 0.06 | 0.002998 | 0.997002 | 499.7002 | 0.299820108 | 1.33848E−05 | 1.60618E−04 |
| 13 | 0.06 | 0.002998 | 0.997002 | 499.7002 | 0.299820108 | 1.33848E−05 | 1.74003E−04 |
| 14 | 0.05 | 0.002499 | 0.997501 | 499.7501 | 0.249875062 | 1.11551E−05 | 1.56172E−04 |
| 15 | 0.05 | 0.002499 | 0.997501 | 499.7501 | 0.249875062 | 1.11551E−05 | 1.67327E−04 |
| 16 | 0.05 | 0.002499 | 0.997501 | 499.7501 | 0.249875062 | 1.11551E−05 | 1.78482E−04 |
| 17 | 0.05 | 0.002499 | 0.997501 | 499.7501 | 0.249875062 | 1.11551E−05 | 1.89637E−04 |
| 18 | 0.05 | 0.002499 | 0.997501 | 499.7501 | 0.249875062 | 1.11551E−05 | 2.00792E−04 |
| 19 | 0.04 | 0.001999 | 0.998001 | 499.8001 | 0.199920032 | 8.92500E−06 | 1.69575E−04 |
| 20 | 0.04 | 0.001999 | 0.998001 | 499.8001 | 0.199920032 | 8.92500E−06 | 1.78500E−04 |
| 21 | 0.04 | 0.001999 | 0.998001 | 499.8001 | 0.199920032 | 8.92500E−06 | 1.87425E−04 |
| 22 | 0.04 | 0.001999 | 0.998001 | 499.8001 | 0.199920032 | 8.92500E−06 | 1.96350E−04 |
| 23 | 0.04 | 0.001999 | 0.998001 | 499.8001 | 0.199920032 | 8.92500E−06 | 2.05275E−04 |
| 24 | 0.04 | 0.001999 | 0.998001 | 499.8001 | 0.199920032 | 8.92500E−06 | 2.14200E−04 |
| 25 | 0.04 | 0.001999 | 0.998001 | 499.8001 | 0.199920032 | 8.92500E−06 | 2.23125E−04 |
| 26 | 0.04 | 0.001999 | 0.998001 | 499.8001 | 0.199920032 | 8.92500E−06 | 2.32050E−04 |
| 27 | 0.04 | 0.001999 | 0.998001 | 499.8001 | 0.199920032 | 8.92500E−06 | 2.40975E−04 |
| 28 | 0.04 | 0.001999 | 0.998001 | 499.8001 | 0.199920032 | 8.92500E−06 | 2.49900E−04 |
| 29 | 0.04 | 0.001999 | 0.998001 | 499.8001 | 0.199920032 | 8.92500E−06 | 2.58825E−04 |
| 30 | 0.04 | 0.001999 | 0.998001 | 499.8001 | 0.199920032 | 8.92500E−06 | 2.67750E−04 |

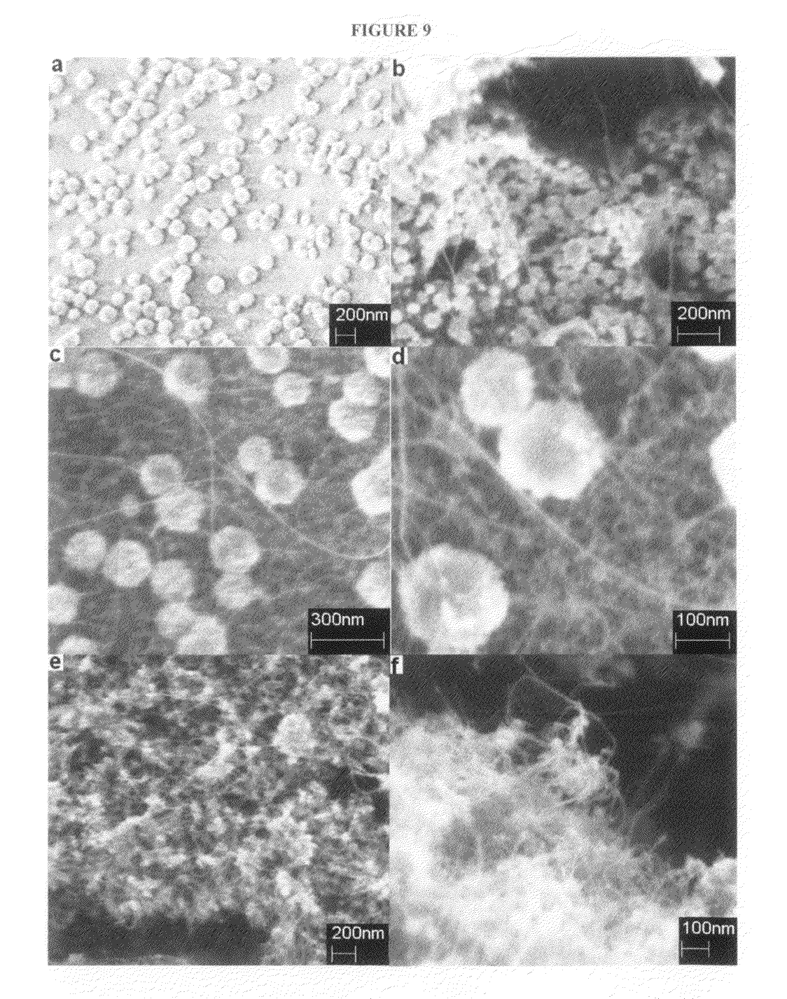

SEM images for the SWNTs deposited at 650-750° C. are shown in FIGS. 9a-9f. FIGS. 9a-9f depict SEM images of as-prepared SWNTs at different temperatures: a) 650° C., b) 675° C., c) 700° C., d) 700° C., e) 725° C., and f) 750° C. In general, no nanotubes were found in the sample grown at 650° C. and only sparse growth was observed for a sample prepared at 675° C. 700° C. was found to be one effective temperature both with regard to nanotube growth and stability of catalyst particle size. As the growth temperature was further increased to 725° C. and 750° C., the SEM images from the samples show significant growth of nanotubes but the catalyst particles appear to be randomly oriented. In addition, the Raman spectra show low RBM line intensities for samples grown at higher temperatures suggesting that the nanotubes are bundles of thin MWNTs and not SWNTs.

### Effect of CO Flow Rate:

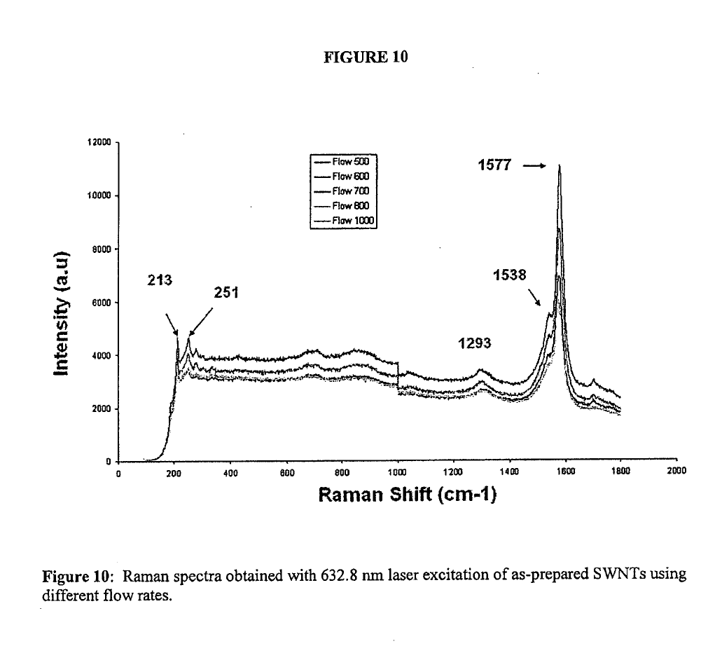

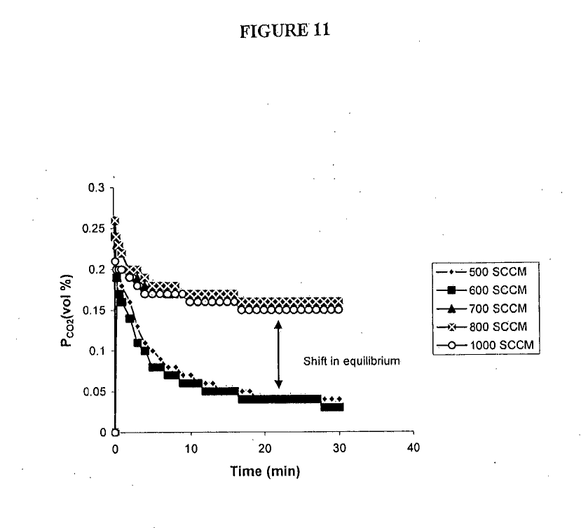

In order to investigate the influence of the carbon monoxide flow rate on the SWNT yield and purity, the flow rates were varied within the range of 500 sccm to 1000 sccm. The flow rate was controlled using a Sierra Instruments mass flow meter, with a range of 0-2 L/min. Once again all other conditions such as, for example, 100% CO as carbon source, 0.030 gms of Co:Mo (1:4) catalyst, growth temperature of 700° C., deposition time of 30 minutes, and atmospheric pressure, were maintained constant. FIG. 10 shows typical Raman spectra obtained from the as-prepared SWNTs for flow rates of 500, 600, 700, 800, and 1000 sccm. The Raman spectra of the SWNTs generally indicate no shift or change in peak positions as a function of CO flow rate. Also, the ratio for D to G⁺ line intensities remains essentially the same for all the flow rates. However, it can be observed that the SWNT line intensities are highest for a flow rate of 700 sccm and this is consistent with the exit CO₂ gas concentration data shown in FIG. 11. The peak positions of 213 and 251 cm⁻¹ correspond to average SWNT diameters of 1.13 and 0.94 nm, respectively.

Nanotube diameter may be controlled via the size of the catalyst particles used. This may be seen in FIG. 10, which shows the Raman spectra of nanotubes produced as a function of the flow rate of carbon monoxide. The peaks at 213 and 251 cm⁻¹ corresponding to nanotube diameters of 1.13 and 0.94 nm, respectively, are seen for all of the preparations.

In general, there is no observable change in the RBM peak positions at flow rates between 500 to 1000 sccm suggesting that at higher flow rates the SWNT diameters can be controlled within a narrow range. As discussed earlier, low flow rates produce SWNTs with smaller diameters corresponding to RBM peaks at 240 and 276 cm⁻¹ for the same growth conditions. As depicted in FIG. 11, the exit CO₂ gas concentrations are almost the same for CO flow rates of 700, 800 and 1000 sccm. There is a shift in the equilibrium concentration from 0.03-0.04 vol % to 0.16-0.17 vol % when the CO flow rates are changed from 600 to 700 sccm. For example, this may be attributed to the increase in rate of removal of carbon dioxide at higher flow rates; therefore the reverse Boudouard reaction slows down and leads to a shift in the equilibrium. In general, this suggests that at higher flow rates a higher conversion of CO to SWNTs may be obtained. From the experimental data shown in FIG. 11 and following the calculation shown in Table 3, the carbon yields after 30 minutes on a weight basis for different flow rates of 500, 600, 700, 800 and 1000 sccm at a temperature of 700° C. are 10.7, 48.14, 59.90, 68.46, 80.23%, respectively.

### Effect of Initial Partial Pressure of CO:

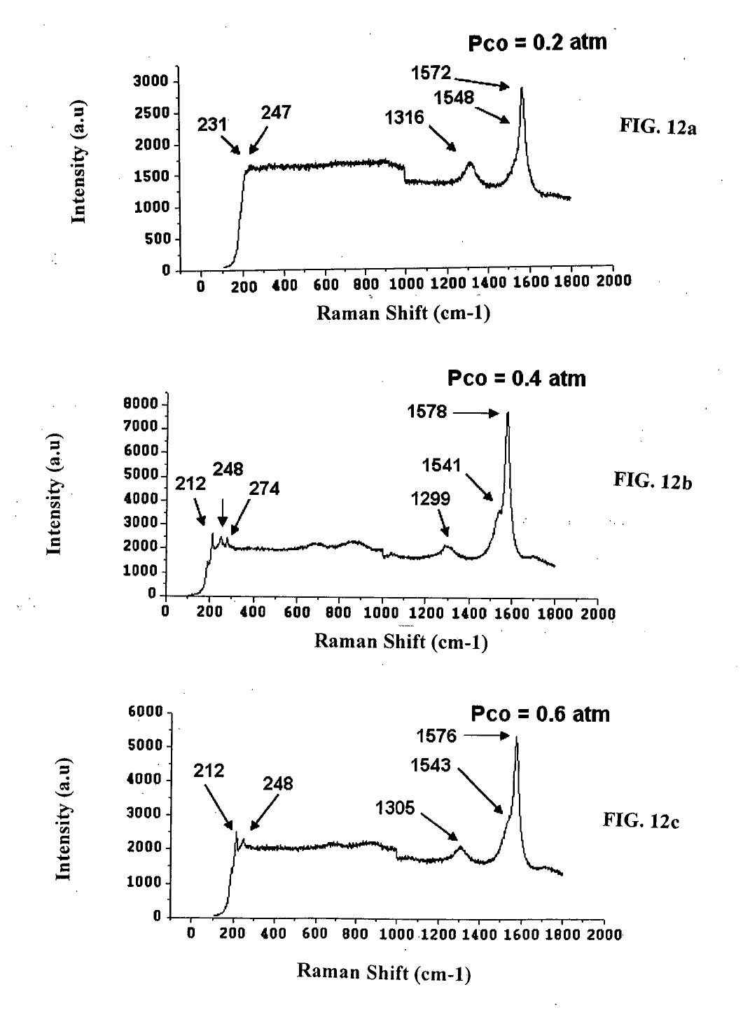

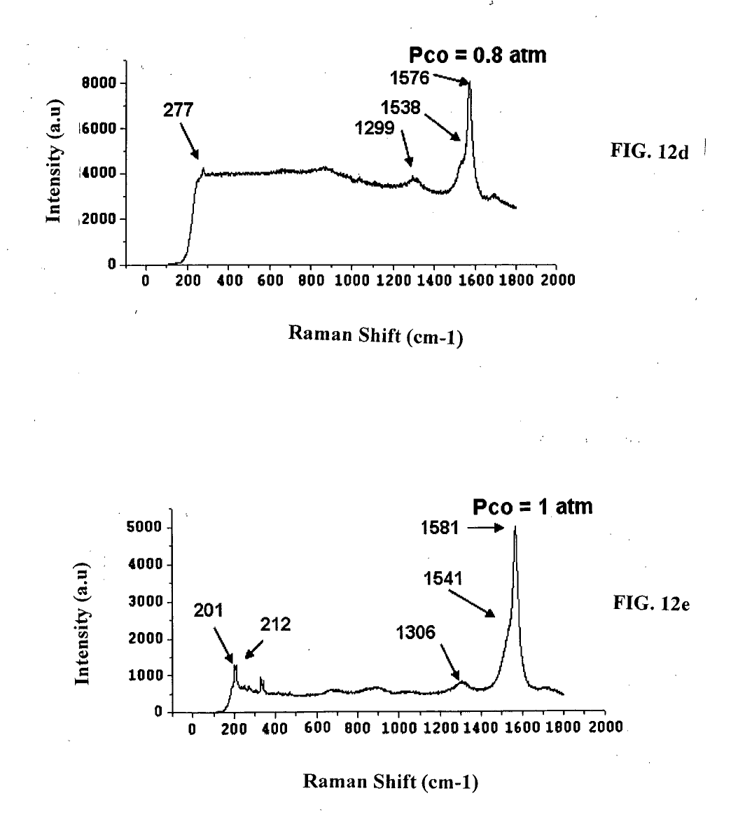

In order to investigate the effect of a diluted carbon precursor feed or feedstock, experiments were conducted by maintaining all other parameters constant while changing the volumetric flow ratio of carbon monoxide to argon, so as to have initial partial pressures of CO (P_{CO}) of 0.2, 0.4, 0.6, 0.8 and 1 atm. FIG. 12a-12e show representative Raman spectra for as prepared SWNTs after a growth time of 30 minutes under these conditions. From FIG. 12a at P_{CO}=0.2 atm, SWNT growth is observed as indicated by the appearance of weak RBM lines. For samples prepared at P_{CO} of 0.4 atm and above, relatively intense RBM and TM lines as shown in FIGS. 12b-12e.

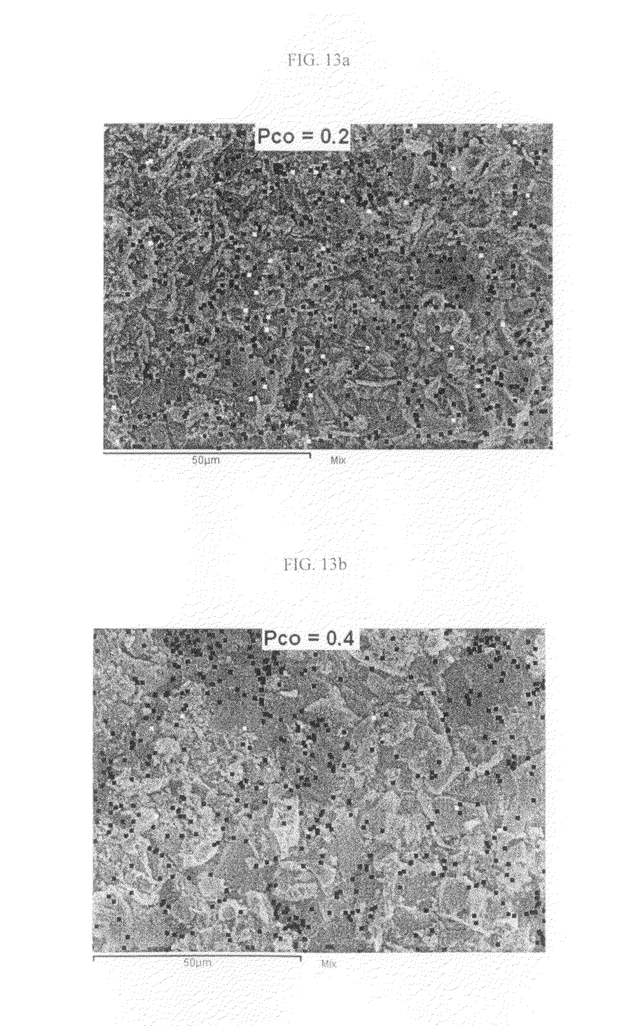

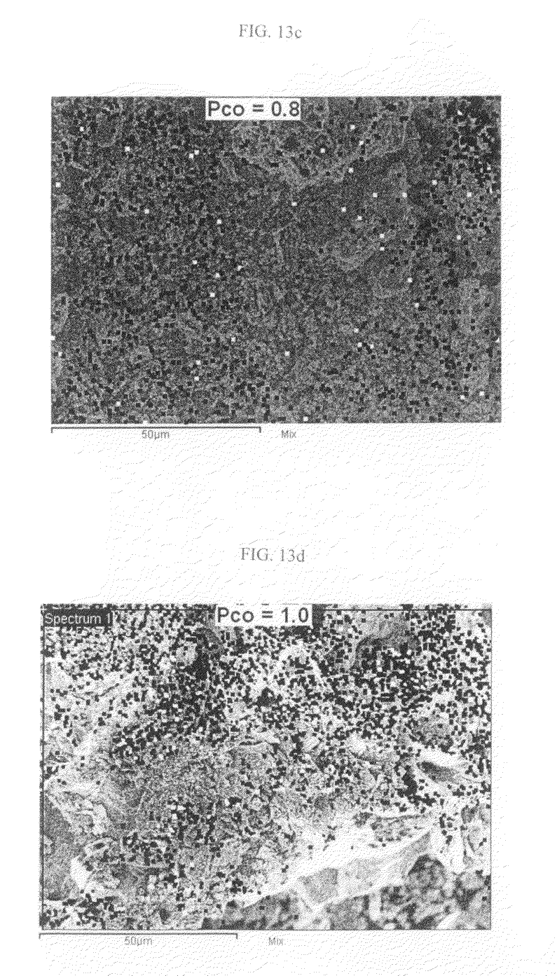

As the CO pressure is increased the peak position of RBM line varies, indicating changes in the SWNT diameters. This was not the case when SWNTs were prepared as a function of the CO flow rate, for example. The RBM line peaking at 210-214 cm⁻¹ corresponding to a SWNT diameter of ˜1.1 nm was found consistently in several of the samples. XRD and TEM studies discussed below reveal a similar diameter distribution. An EDX study (FIG. 13) was also conducted to find the number of active catalytic sites (cobalt) occupied by the carbonaceous species after deposition. The maps for cobalt and carbon on the samples are shown in FIG. 13. For example, the EDX measurement conditions (e.g., working distance of 9 mm, constant area and time ˜300 sec for scan and energy of 6 keV) were kept constant. The statistical quantitative analyses data from the images obtained are listed in Table 4. Irrespective of the change in partial pressure from 0.2 atm to 1 atm of CO, the catalyst sites occupied was found to be in the range of 80-85%. These two observations were used for the scale up, as non-diluted higher flow rates of CO would generally not be safe to use. In the fluidized bed scheme for the same reaction, the H₂ and CO feed is diluted with N₂ both in the reduction and deposition stages, respectively.

TABLE 4
An Estimate of Catalytic Site Occupation as a Function of Inlet
CO Pressure from Corresponding Images Shown in FIG. 13

| | Total no. of | Sites Occupied | |
|---|---|---|---|
| Initial CO | catalytic sites | (green dots | |
| Pressure | (green color | covered | Percentage |
| P_{CO} (atm) | dots) | by red dots) | occupation |
| 0.2 | 46 | 38 | 80.00 |
| 0.4 | 71 | 58 | 83.33 |
| 0.6 | 6 | 5 | 81.70 |
| 0.8 | 45 | 36 | 82.61 |
| 1.0 | 148 | 126 | 85.13 |

### Purification:

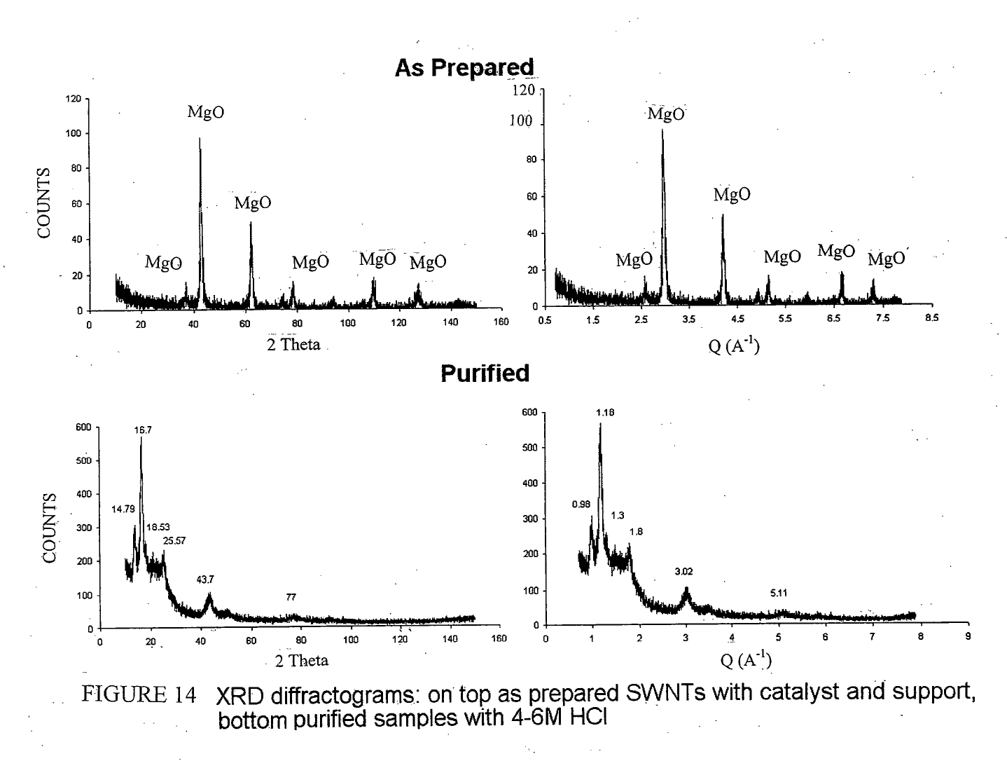

An XRD study was done primarily to investigate the efficiency of the purification method used to remove the catalyst support material/catalyst composition (e.g., MgO/Co—Mo) from as-prepared SWNTs. The diffractograms (FIG. 14) are plotted both as x-ray intensity versus 2θ and Q (Å⁻¹)=4π Sin θ/λ and shown for as-prepared and purified samples. The data shows that MgO reflections are generally not observed for the purified sample (Swanson, 1953). In addition, from the XRD patterns for the purified samples in the region below Q<2 Å⁻¹, four peaks at 0.98, 1.18, 1.3, and 1.8 Å⁻¹ are observed consistent with the 2D triangular lattice of SWNT bundles as reported in earlier studies (e.g., Thess, 1996). A small, sharp peak at 1.85 Å⁻¹ is close to the graphite (002) position. The reflection at Q=0.43 Å⁻¹ could not be observed since the diffractometer used cannot resolve small angle reflections. Also, from the (110) reflection at 2θ=77.25° (FIG. 14) d₁₁=12.4 nm can be calculated using Bragg's equation, for example. Therefore for a bundle of 10 SWNTs arranged in a hexagonal packing, an individual SWNT diameter of 1.1 nm can be estimated (e.g., Bandow, 1997) which is generally consistent with the average individual tube diameter obtained from the Raman and TEM data.

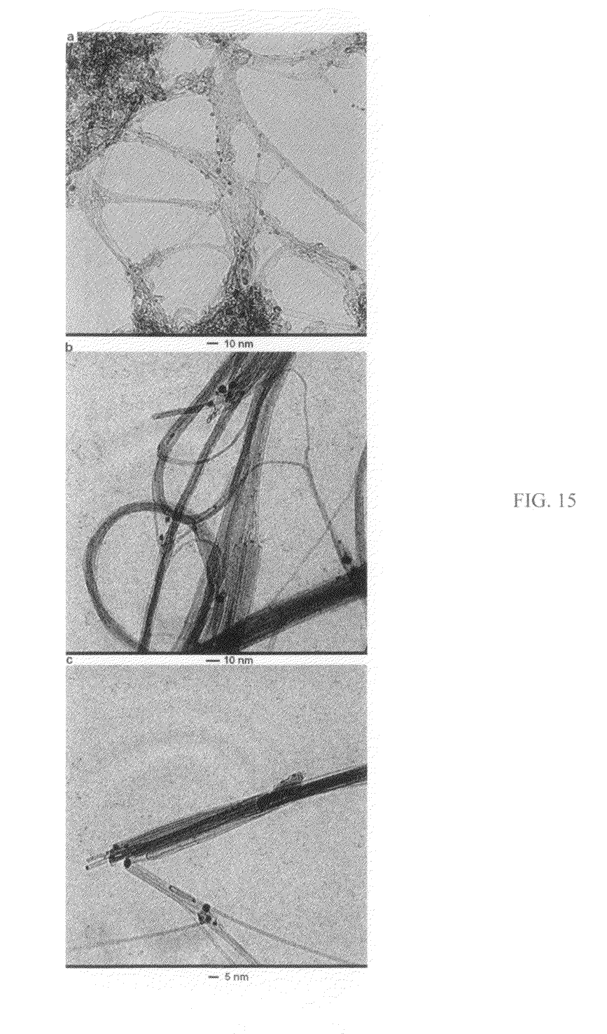

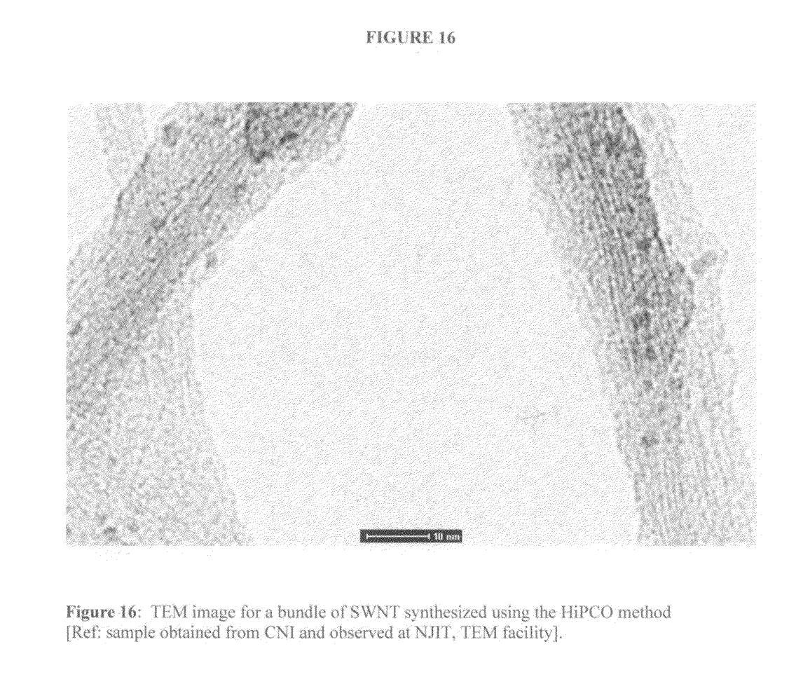

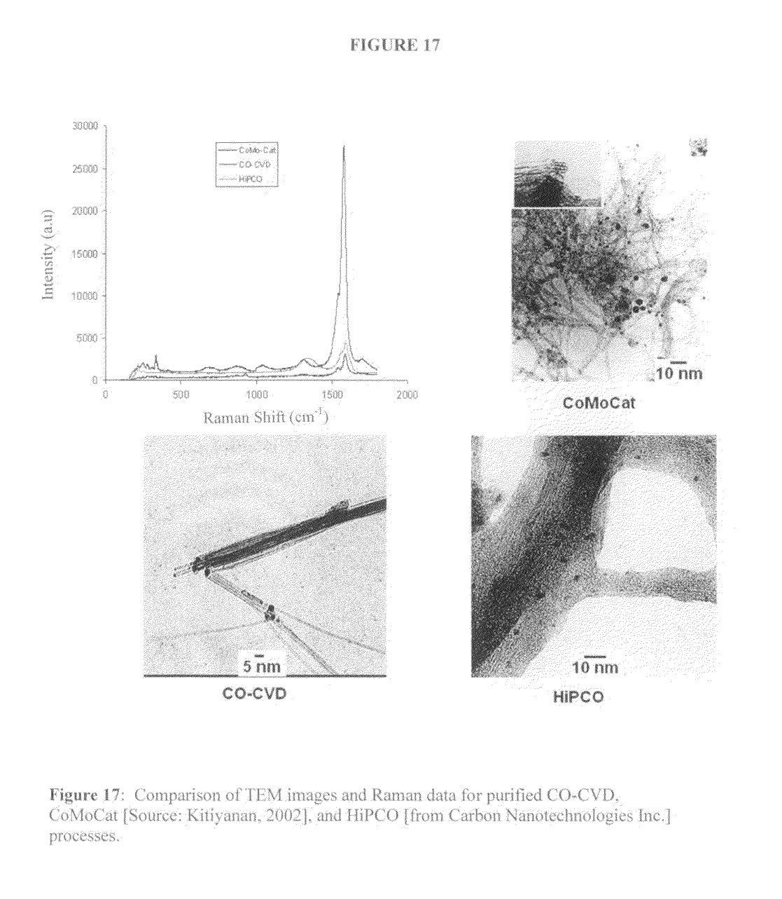

The TEM images of as-prepared and purified SWNTs grown on MgO are shown in FIG. 15. FIG. 15 depicts TEM images of SWNTs: a) as-prepared with catalyst and support, b) after HCl acid purification, and c) after partial oxidation. From the TEM image in FIG. 15a it may be seen that only small amounts of amorphous carbon are present. The support material MgO can be seen at the top left and bottom of the image while catalyst particles are dispersed on the nanotube bundles and MgO. The image in FIG. 15b shows that HCl purification has removed almost all of the MgO support consistent with the XRD data in FIG. 14; however, small amounts of amorphous carbon and catalyst particles attached to the SWNTs still remain. The TEM images therefore show that these purified samples are comprised of thin bundles of SWNTs compared to HiPCO SWNTs, which generally form larger bundles of 20-100 nanotubes (see FIG. 16). In order to remove residual amorphous carbon that cannot dissolve in HCl, a partial oxidation procedure was conducted. TGA data show that SWNT oxidation occurs at 600° C. in air (e.g., Hata, 2004). SWNTs were therefore partially oxidized using water (a weak oxidant) through which flowing argon at 300 sccm was bubbled over SWNTs maintained at a temperature of 450° C. In general, amorphous carbon has been reported to oxidize in air at 300° C. For example, the TEM image from a weakly oxidized sample shown in FIG. 15c indicates defect free walls with very few catalyst particles attached mainly to the tips. The average diameter of the SWNTs is ˜1.1 nm, consistent with the Raman and XRD data discussed earlier. FIG. 17 shows an overall comparison of SWNTs obtained by CO-CVD, CoMoCat, and the HiPCO processes based on TEM images and Raman spectra taken from corresponding samples.

### Kinetic Model for SWNT Deposition:

In general, chemical vapor deposition (CVD) is a useful process in the microelectronics industry since one step in the chip-making process is the deposition of different semiconductors and metals on the surface of a chip. For example, this step is typically achieved by CVD. A number of CVD reactors have been studied in the past, such as, for example, barrel reactors, boat reactors, and horizontal and vertical reactors, to study reaction kinetics. In this study of the present disclosure, for example, a boat reactor was used where a small amount of catalyst was placed in ceramic or quartz boats inside the reaction chamber. A model to develop the rate law of the catalytic reaction that is not diffusion-limited is presented. Since, at low pressures there is typically a large increase in the diffusion coefficients, surface reactions are more likely to be rate controlling than the mass transfer. The reaction of interest is the Boudouard reaction involving the decomposition of two molecules of gaseous CO to form one molecule of gaseous CO₂ and a carbon atom in solid C.

In general, the overall Boudouard reaction is:

2CO(g) [symbol] C(s)+CO₂(g)

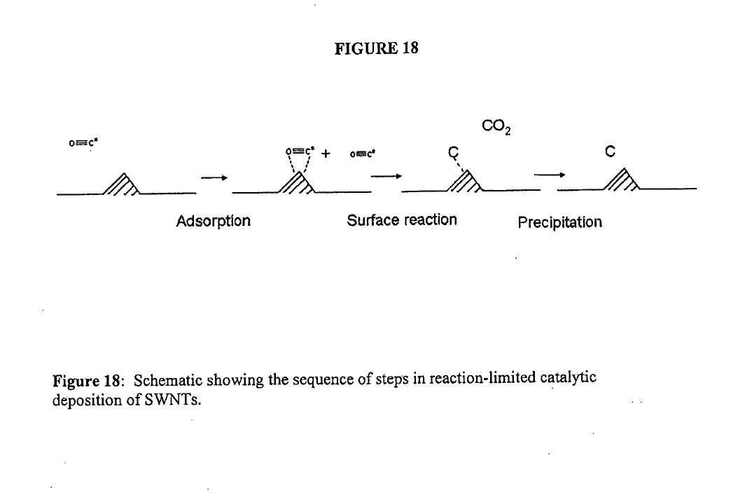

A model depicting the sequence of steps in the cobalt-catalyzed Boudouard reaction is shown in FIG. 18. In FIG. 18, the dashed lines show the formation of a complex with the catalytic site, whereas solid lines show the bonding of a molecule to the catalytic site. Generally, the model can be represented by the following reaction steps:

CO(g)+S^{k1} [symbol] ₖ₂CO.S (Adsorption of carbon monoxide on the cobalt surface)

CO.S+CO(g)^{k3} [symbol] ₖ₄C.S+CO₂ (Surface reaction to form adsorbed carbon and carbon dioxide in the gas phase)

CS^{k5} [symbol] Cs+S (Precipitation of carbon out of the cobalt surface)

where,
k1 is the rate of the forward adsorption reaction
k2 is the rate of the backward adsorption reaction
k3 is the rate of the surface reaction
k4 is the rate of the forward precipitation reaction
k5 is the rate of the backward precipitation reaction
   Units for reaction constants (mole/atm min)
   The proposed mechanism is based on the following assumptions, for example:
1. The adsorption and surface reaction which leads to desorption of CO₂ reactions rapidly approach equilibrium.
2. Precipitation of carbon is rate-limiting. This is the classic Eiley-Rideal mechanism where reaction between an adsorbed molecule and a gas phase molecule takes place.

### Therefore,

R_{ads}=k₁P_{CO}[S]−k₂[CO.S]=0

Rₛᵤᵣ=k₃P_{CO}[CO.s]−k₄[C.S]P_{CO2}=0

Rₚᵣₑ=k₅[C.S]

Or,

K_{ads}=k1/k2=[CO.S]/(P_{CO}[S])

And,

Kₛᵤᵣ=k3/k4=([C.S]P_{CO2}/([CO.S]P_{CO})

The site balance is given by:

Sₒ=[S]+[CO.S]+[C.S]

where,
So=Total number of initial catalytic sites
S=Available sites for reaction at any given time
CO.S=Sites occupied by CO to form an intermediate complex
C.S=Sites occupied by C atoms to form a complex

The rate-limiting is generally the precipitation reaction. Therefore,

Rₚᵣₑ=R_{c}=(dC_{c}/dt)=[(k₅KₛᵤᵣK_{ads}P_{CO}²)/P_{CO2})]*[(S₀)/(1+K_{ads}P_{CO}+KₛᵤᵣK_{ads}*(P_{CO}²/P_{CO2}))]

Where, Rₚᵣₑ is the rate of precipitation and is equivalent to rate of formation of carbon R_{c}. K_{ads} and Kₛᵤᵣ decreases with increasing temperatures. Therefore at high temperatures it is a good approximation that 1>>K_{ads}P_{CO}+KₛᵤᵣK_{ads}(P_{CO}²/P_{CO2})

### Therefore,

Rₚᵣₑ=R_{c}=(dC_{c}/dt)=[(K_{reaction}P_{CO}²S₀)/(P_{COinitial}−P_{CO})]

Considering that the total number of initial sites is equal to 100% or 1 in the beginning:

Rₚᵣₑ=R_{c}=(dC_{c}/dt)=[(K_{reaction}P_{CO}²)/(P_{COinitial}−P_{CO})]

### Therefore,

C_{c}=¹∫₀K_{reaction}[(P_{CO}²)/(P_{COinitial}−P_{CO})]dt

Thus, carbon deposited typically is first order with respect to the concentration of carbon monoxide.

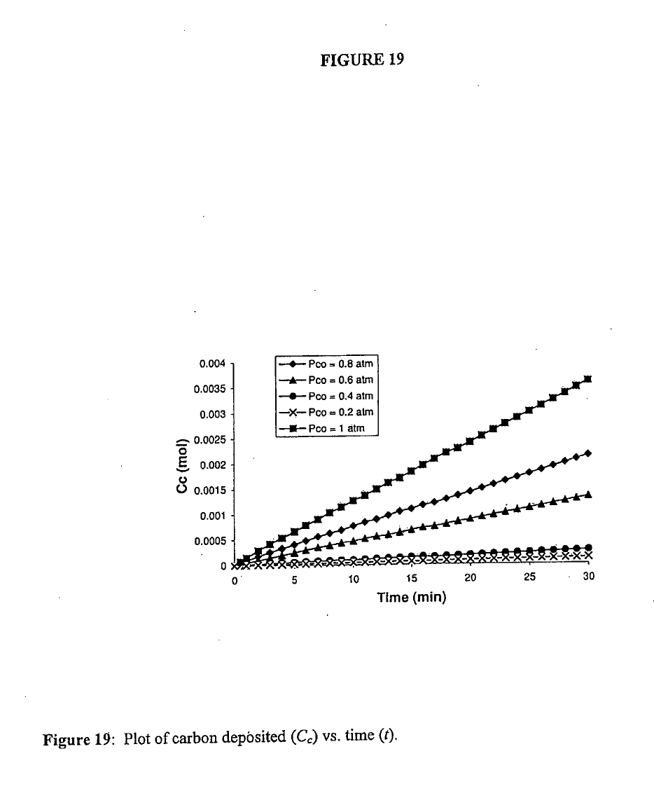

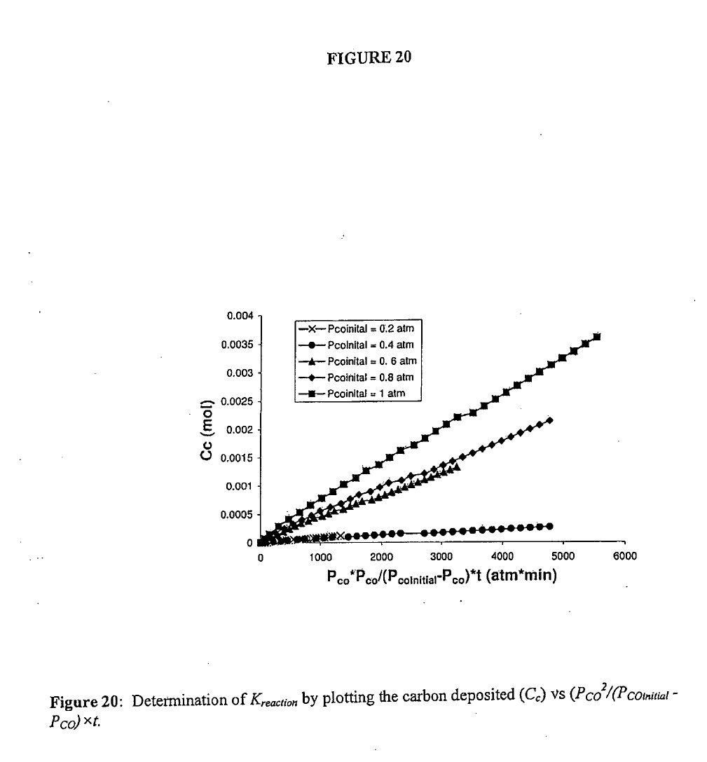

In general, the experimental data agrees with the above model as shown by the linear dependence of the plot of the carbon deposited (C_{c}) against time (t) in FIG. 19. As shown in FIG. 20, the carbon deposited (C_{c}) is plotted against (P_{CO}²/(P_{COinitial}−P_{CO}))×t, at different initial carbon monoxide partial pressures (P_{COinitial}). From FIG. 20, the K_{reaction} values at different P_{COinitial} can be determined as slopes of the plots after linear regression. The K_{reaction} values are listed in Table 5.

TABLE 5
Kinetic Coefficients at Different Inlet Carbon Monoxide Pressures

| P_{COinitial} | K_{reaction} | |
|---|---|---|
| (atm) | (mole/atm × min) | I(D)/I(G⁺) |
| 0.2 | 9.00E−08 | 0.584 |
| 0.4 | 6.00E−08 | 0.279 |
| 0.6 | 4.00E−07 | 0.395 |
| 0.8 | 5.00E−07 | 0.475 |
| 1 | 7.00E−07 | 0.159 |

It is noted that the model reports the formation of carbon, as well as SWNTs. In order to segregate the amorphous carbon to form SWNTs, the reaction equation may be multiplied by the I(D)/I(G⁺) ratio which is a measure of the selectivity towards nanotube formation. The I(D)/I(G⁺) ratios of intensities obtained from the Raman data (FIG. 12) are listed in Table 5. It was already noted from earlier observations that the number of catalyst sites occupied by the carbonaceous species is independent of the initial partial pressure of CO. Therefore if fresh catalyst is fed into the reactor, the kinetics does not depend on past history and can be treated separately, where a decay or selectivity coefficient can be multiplied by the rate equation. Therefore,

C_{c}=1/[(I(D)/I(G⁺)¹∫_{O}K_{reaction}[(P_{CO}²)/(P_{COinitial}−P_{CO})]dt

### Fluidization Bed Reactor for Scale Up of SWNT Synthesis:

In exemplary embodiments of the present disclosure, it was previously concluded above that SWNTs may be selectively synthesized with the diameter controlled in a narrow range of flow rates using Co:Mo (1:4) catalyst supported on MgO at 1 atm of pure CO feed at a temperature of about 700° C., for example. It was also observed that as the CO feed is diluted with an inert gas the rate of formation of nanotubes generally decreases with a minimum at a CO partial pressure (P_{COinitial}) of 0.2 atm. In general, this condition is not favorable for the production of SWNTs. However, for safety reasons, for example, pure CO typically cannot be used at high flow rates in a typical laboratory environment. An initial study using some of the findings from the small scale reactor was used to demonstrate the formation of a large batch of nanotubes in a cost-effective manner. As mentioned earlier in the experimental section, the catalyst/support preparation procedure was somewhat modified in order to make the larger quantities required to achieve the required depth of the bed.

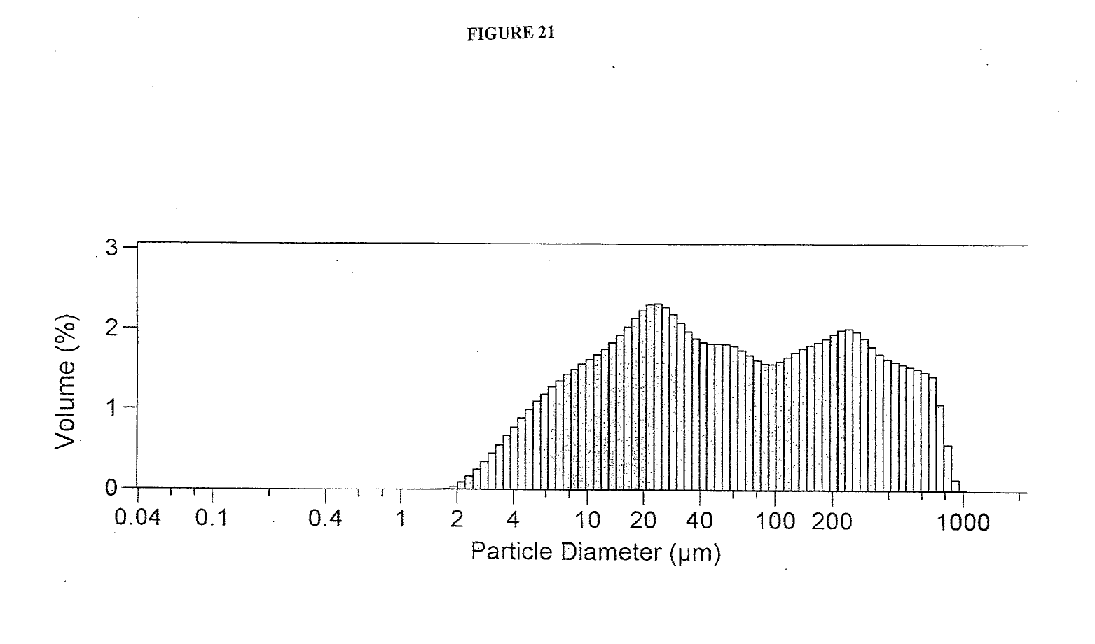

There are few reports in the art regarding the use of a fluidized bed system to synthesize carbon nanotubes and most are limited to MWNTs (e.g., Wang, 2002; Weizhong, 2004; Mauron, 2002). In general, production of fine particles such as carbon nanotubes may be considered a challenging task in the field of powder technology research. Initial experiments in this study of the present disclosure were carried out on the MgO powder of −325 mesh, which is equivalent to 44 μm and below. For example, before choosing the size of the MgO particles, the particle size distribution of the optimized catalyst was carried out using a Beckman Coulter LS series particle size analyzer in order to understand the relative size distribution of the catalyst that is largely constituted of MgO (greater than or equal to 95%). FIG. 21 shows that the particle size distribution of the MgO support typically varies from about 2 μm to about 1000 μm with the highest volume fraction of particles typically having sizes of about 20 and about 300 μm. The mean particle size observed is about 143 μm. The large variation in particle size indicates the formation of agglomerates. One consideration to understand is catalyst composition/catalyst support material particle size distributions scale up issues. Since most of the calculations for fluidizing the bed typically depends on a nominal particle size, the loss of particles due to entrainment can be estimated by knowing the volume fraction of particles smaller than the mean size present in the bulk catalyst/support powder. In addition, formation of agglomerates is generally favorable for reduction in loss due to entrainment, at the same time it generally increases the difficulty of fluidizing the whole bed uniformly, for example.

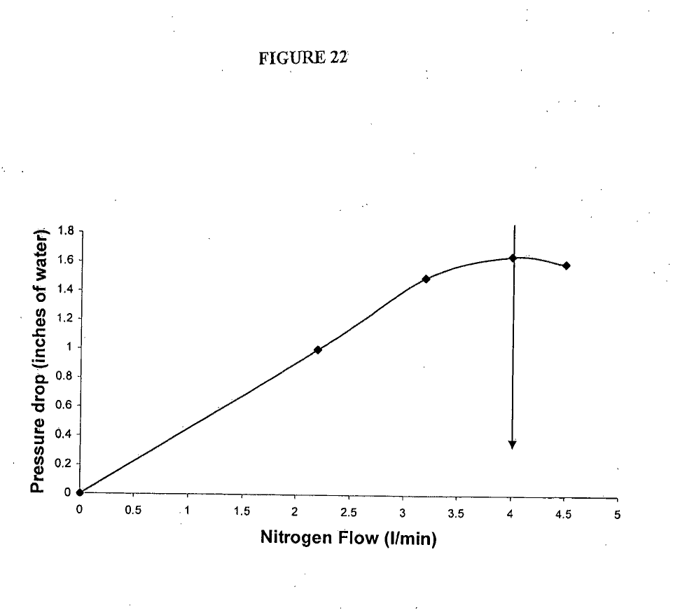

The −325 mesh MgO powder was further sieved using 500 μm pore sieve (35 mesh) to retain about all of the agglomerates and to remove larger chunks of particles. A 2 inch quartz tube with a ceramic gas distributor (pore size 40 μm) at the bottom was used to determine the minimum fluidization velocity required. FIG. 22 shows a plot of the pressure drop versus the flow of N₂. The experimental minimum fluidization velocity was found to be between 0.033 msec, which is equivalent to about 4 liters/min., with tube cross section area of about 0.00202 m².

### Calculation for Minimum Fluidization Velocity:

For example, using the Ergun equation for pressure drop in packed beds (e.g., McCabe, 5th ed. 1993):

ΔPg_{c}/L=[(150 μ\tilde{V}₀(1−ε²)]/(θₛ²Dₚ²ε³)+[1.75ρ\tilde{V}₀²(1−ε)]/(θₛDₚε³)

where,
ΔP is the pressure drop
gc is the acceleration due to gravity
μ is the viscosity of gas phase
Dₚ is the particle diameter
Vₒ is the superficial velocity
ε is the void fraction
ρ is the density of gas phase
ρₚ is the density of particle,
all in SI units.

In the case of incipient fluidization a quadratic equation may be obtained:

[150 μ\tilde{V}_{0M}(1=ε_{M})/θₛ²Dₚ²ε_{M}³]+(1.75\tilde{V}_{0M}²)/θₛDₚε_{M}³=g(ρₚ−ρ)

where the subscript M refers to a minimum value. For very small particles, typically only the laminar flow term of the Ergun equation is significant. Also, for spherical particles the void fraction ε_{M} is 0.40. Therefore, for example, for particle Reynolds number, N_{Re,P}<1, the above equation reduces to:

\tilde{V}_{0M}≈[(g(ρₚ−ρ)ε_{M}³)/(150μ(1−ε_{M})]θₛ²Dₚ²

For a particle size of 143 μm, 4 liter/min of volumetric flow rate (experimental data), nitrogen gas density of 1.256 Kg/m³, and viscosity of 0.0180, N_{Re,P} is equal to 0.33 using the following equation:

N_{Re,P}=(DₚVρ)/μ

Therefore, for example, minimum fluidization velocity (\tilde{V}_{0M}) for this case using the equation above (\tilde{V}_{0M}≈[(g(ρₚ−ρ)ε_{M}³)/(150μ(1−ε_{M})]θₛ²Dₚ²) is 0.028 m/sec.

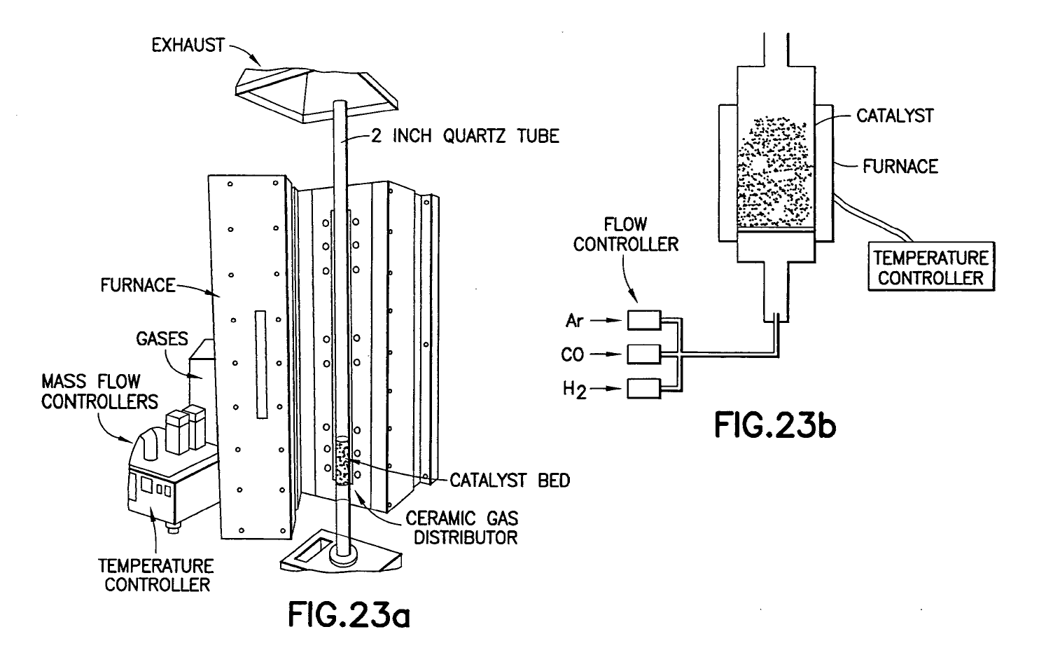

The velocity equivalent of the volumetric flow rate of 4 liter/min with the cross section area of the tube=0.002025 m², is 0.032 msec. Therefore, the experimentally observed velocity (0.032 m/sec) is slightly higher than the calculated velocity of 0.028 msec. This suggests that the particulate forms bigger agglomerates than that indicated by the particle size distribution. This may be possible because MgO is generally known to be hygroscopic at ambient conditions. In addition, while determining size of the particle size distribution, the particles were sonicated resulting in de-segregation. FIG. 23a shows a photograph of the fluidized bed experimental setup used in this work and FIG. 23b shows a schematic of the scale up process.

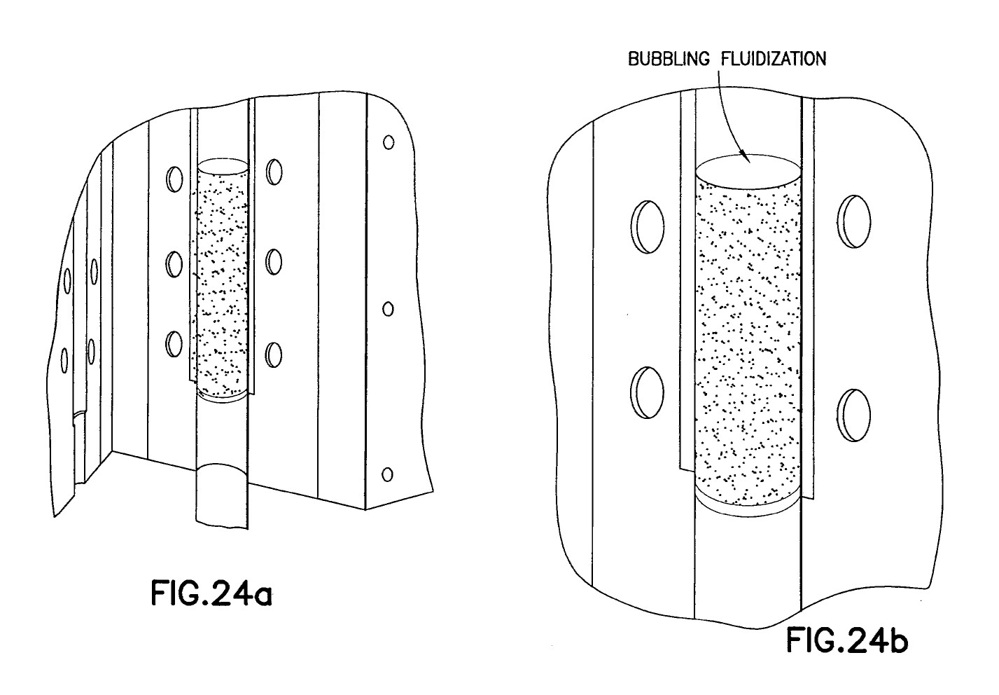

For the experiment carried out, a 110 gm batch of catalyst/support was introduced into the reactor tube resulting in a bed height of 10.5 cm. The bed fluidized uniformly to a height of about 13.5 cm and a bubbling type of fluidization was observed. As the gas flow was increased the bed height remained uniform, suggesting that the expansion of the bed may come from the space occupied by gas bubbles. Photographs of the fluidized bed experiment are shown in FIG. 24.

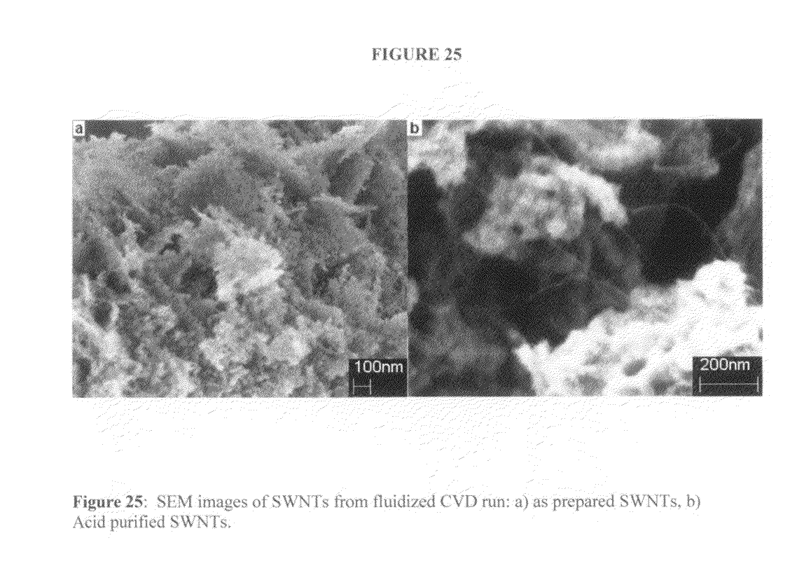

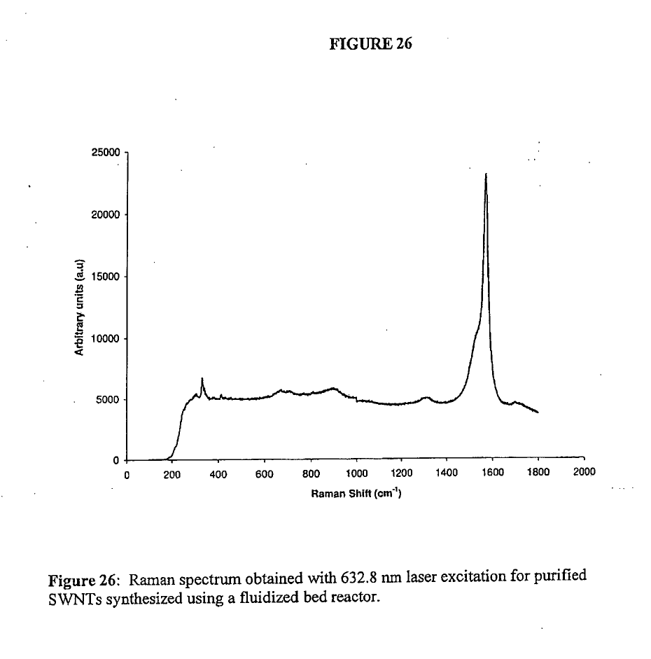

SEM and Raman analysis were conducted on the samples after fluidized CVD deposition, indicating the formation of SWNTs, but at low yields. It may be that the low yields were due to the lowered concentrations of CO used in the run (e.g., due to safety considerations and use of a reducing gas environment with low H₂ concentrations). FIG. 25a is a representative SEM image obtained from the as prepared sample and FIG. 25b is from a purified sample. Due to the relatively large amount of MgO and low SWNT yield, it was difficult to observe SWNTs in the as prepared sample. However, after briefly cleaning (1 hr) with 4M HCl, SWNTs were visible. A Raman spectrum from the purified tubes is shown in FIG. 26, where features for the SWNTs can be observed in the RBM and TM regions of the spectrum.

As such, an exemplary carbon monoxide chemical vapor deposition (CO-CVD) method was developed and optimized for the production of SWNTs in a scalable manner. For example, two furnaces, one a horizontal furnace with a small scale boat type reactor and another, a large-scale vertical furnace with a fluidized bed reactor, were set up and characterized for nanotube growth. A Co—Mo/MgO catalyst/support system was studied and it was found that Co is the effective catalyst and/or active catalyst precursor, while Mo acts as co-catalyst, promoter and/or catalyst promoter precursor for nanotube growth. It was also observed that if Co is present in excess of Mo, the catalyst may become random in shape and size. Spherical monodisperse catalyst of composition Co:Mo in the ratio of 1:4 with the remaining comprised of MgO as catalyst support material, was found to be effective for nanotube growth. Effective conditions for growth of SWNTs using the small scale reactor were determined in this study. It was observed that nanotube growth initiates at a temperature of about 650° C. and above, with one effective temperature being a temperature around about 700° C. The I(D)/I(G⁺) ratios associated with the intensities of the disorder and graphitic lines of the SWNTs, respectively, determined from the Raman data, confirmed this observation. From Co—Mo-carbon phase diagram it was inferred that the Co catalyst converts from the β to the α-phase at the nanotube growth temperature in the presence of Mo, and 1.7 wt % carbon is typically needed to supersaturate the catalyst metals. Purification of SWNTs was carried out using 4-6 M HCl and thin bundles of very high quality SWNTs were observed with transmission electron microscopy. XRD data revealed complete removal of MgO support after HCl purification. Yields of about 10% by weight of SWNTs were obtained in these small scale experiments. As the flow rate was increased the exit CO₂ gas concentration data revealed a shift in equilibrium suggesting that higher yields may be obtained with increasing flow rates. It was found that the partial pressure of CO above 0.2 atm is typically needed for nanotube growth; however, the percentage occupation of catalyst sites generally did not vary with the partial pressure of CO. A rate limited kinetic model with precipitation as the rate limiting step in conjunction with the observed experimental growth was proposed and fitted well with the experimental data. In general, the SWNT formation reaction was observed to follow first order kinetics. An initial scaled up experiment carried out in a fluidized bed using the large-scale vertical furnace showed the formation of SWNTs, but at low yields probably due to the relatively low concentration of CO used due to safety considerations, for example.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A method for producing single wall carbon nanotubes comprising:
contacting a catalyst composition and a catalyst support material with at least one reducing gas in a reaction zone under reduction conditions;
contacting the catalyst composition and the catalyst support material with a carbon feedstock in gaseous form at a pressure of from about 0.20 atm to about 1.0 atm and at a temperature of from about 600° C. to about 850° C. in the reaction zone under thermally-induced catalytic chemical vapor deposition conditions to produce single wall carbon nanotubes;
wherein the particle size distribution of the catalyst composition and the catalyst support material is from about 2 μm to about 1000 μm.

2. The method of claim 1, wherein the catalyst support material is magnesium oxide.

3. The method of claim 1, wherein the catalyst support material has an average particle size of about 44 μm.

4. The method of claim 3, wherein the catalyst support material is magnesium oxide.

5. The method of claim 1, wherein the catalyst support material is a −325 mesh powder.

6. The method of claim 5, wherein the catalyst support material is magnesium oxide.

7. The method of claim 1, further including the step of sieving the catalyst support material and the catalyst composition prior to contacting the catalyst support material and the catalyst composition with the at least one reducing gas.

8. The method of claim 1, wherein the particle size distribution has a highest volume fraction having particle sizes of from about 20 μm to about 300 μm.

9. The method of claim 1, wherein the particle size distribution has a mean particle size of about 143 μm.

10. The method of claim 7, wherein the catalyst support material and the catalyst composition are sieved using a 500 μm pore size or 35 mesh sieve.

11. The method of claim 1, wherein the catalyst composition and catalyst support material are contacted with the carbon feedstock at a temperature of about 700° C.

12. The method of claim 1, wherein the carbon feedstock includes at least carbon monoxide as the carbon source.

13. The method of claim 1, wherein the catalyst composition comprises an active catalyst precursor and a catalyst promoter precursor.

14. The method of claim 13, wherein the active catalyst precursor is selected from the group consisting of cobalt, nickel, iron and combinations thereof.

15. The method of claim 13, wherein the catalyst promoter precursor is molybdenum.

16. The method of claim 13, wherein the active catalyst precursor is cobalt nitrate, the catalyst promoter precursor is ammonium heptamolybdate or molybdenum nitrate, and the catalyst support material is magnesium oxide.

17. The method of claim 1, wherein the single wall carbon nanotubes are produced at yields of about 10% by weight of initial catalyst composition and catalyst support material weight.

18. The method of claim 1, wherein the carbon feedstock is contacted with the catalyst composition and the catalyst support material at carbon feedstock flow rates of from about 100 sccm to about 1000 sccm.

19. The method of claim 1, wherein the carbon feedstock is contacted with the catalyst composition and the catalyst support material for a time period of from about 1 minute to about 30 minutes.

20. The method of claim 1, wherein the catalyst composition includes at least cobalt and the catalyst support material is magnesium oxide.

21. The method of claim 1, wherein the catalyst composition includes at least molybdenum and the catalyst support material is magnesium oxide.

22. The method of claim 1, wherein the catalyst composition includes at least cobalt and molybdenum, and the catalyst support material is magnesium oxide.

23. The method of claim 1, wherein the catalyst composition includes at least cobalt and molybdenum, and wherein the cobalt to molybdenum ratio is about 1:4, and wherein the molybdenum is in excess of the cobalt to control the shape and size of the catalyst composition particles.

24. The method of claim 23, wherein the catalyst support material is magnesium oxide and the carbon feedstock is carbon monoxide.

25. The method of claim 1, wherein the catalyst composition includes at least cobalt and molybdenum, and wherein the catalyst composition particles are spherical and monodisperse.

26. The method of claim 1, wherein the catalyst composition particles are spherical and monodisperse.

27. The method of claim 1, wherein the catalyst composition and catalyst support material are contacted with the carbon feedstock at a temperature of from about 650° C. to about 750° C.

28. The method of claim 19, wherein the catalyst composition gradually expires independent of the pressure of the carbon feedstock.

29. The method of claim 1, wherein the diameters of the single wall carbon nanotubes are controllable within a range.

30. A method for producing single wall carbon nanotubes comprising:
contacting a catalyst composition and a catalyst support material with at least one reducing gas in a reaction zone under reduction conditions;
contacting the catalyst composition and the catalyst support material with a carbon feedstock in gaseous form at a pressure of from about 0.20 atm to about 1.0 atm and at a temperature of from about 600° C. to about 850° C. in the reaction zone under thermally-induced catalytic chemical vapor deposition conditions to produce single wall carbon nanotubes;
contacting the single wall carbon nanotubes with acid to remove catalyst support material from the single wall carbon nanotubes to produce acid-purified single wall carbon nanotubes;
partially oxidizing the acid-purified single wall carbon nanotubes with an oxidant under controlled humidity conditions at a temperature of from about 300° C. to about 450° C. to remove amorphous carbon from the single wall carbon nanotubes;
wherein the particle size distribution of the catalyst composition and the catalyst support material is from about 2 μm to about 1000 μm.

31. The method of claim 30, wherein the oxidant is water or water vapor.

32. The method of claim 30, wherein the amount of carbon recovered after acid contact is about 10 weight percent of initial catalyst composition and catalyst support material weight.
